(19) United States
(12) Patent Application Publication
(10) Pub. No.: US 2026/0100582 A1
(43) Pub. Date: Apr. 9, 2026

(54) TRIPPING ENERGY LOADS DURING UNDER-FREQUENCY EVENTS BASED ON DECELERATION OF RATE OF CHANGE OF FREQUENCY

(71) Applicant: XCEL ENERGY INC., Minneapolis, MN (US)

(72) Inventors: Kevin W. Jones, Amarillo, TX (US); Dustin Graham, Amarillo, TX (US)

(21) Appl. No.: 18/905,437

(22) Filed: Oct. 3, 2024

(51) Int. Cl. H02J 3/14; H02H 3/44; H02J 3/00; H02J 3/38

(52) U.S. Cl. CPC H02J 3/17; H02H 3/44; H02J 3/0012; H02J 3/38; H02J 2101/24; H02J 2101/28; H02J 2101/40; H02J 2103/30

(57) ABSTRACT

Systems and methods are disclosed for tripping energy loads in an energy transmission system based on Rate of Change of Frequency (RoCoF). An initial RoCoF of electrical voltage in the energy transmission system is detected and a determination is performed of whether the initial RoCoF falls within a predetermined frequency band. A corresponding amount of energy load to trip is armed, and at least one tripping delay timer is started. While the at least one tripping delay timer is running, a deceleration RoCoF of electrical voltage is detected, and a determination is performed of whether a frequency of the electrical voltage has decayed past a tripping frequency threshold. A time at which to trip the amount of energy load is determined, based at least in part on the deceleration RoCoF of electrical voltage, and the amount of energy load is tripped at the determined time.

### TECHNICAL FIELD

This document generally describes systems, methods, and techniques related to appropriately and quickly controlling the tripping of energy loads during under-frequency events based on a supervised deceleration of a Rate of Change of Frequency (RoCoF), such as when high penetrations of renewable and other inverter-based resources may be present in an electrical grid.

### BACKGROUND

In general, the current electrical grid includes multiple different types of energy sources that produce electricity for consumers connected to the grid. Energy sources for the electrical grid include synchronous energy resources which have inertia, and inverter-based resources (IBR) that have little to no inertia. For instance, synchronous energy resources can generate power through the use of generators that have rotating masses spinning at a particular rate of revolution (e.g., 60 revolutions per second) to provide alternating current (AC) at a corresponding and consistent frequency (e.g., 60 Hz). These synchronous energy resources can generate power through the use of a fuel (e.g., coal, oil, natural gas, nuclear, etc.). When the fuel is consumed, water is heated in a boiler until it changes state to steam. The steam is passed through a turbine that turns the generator to produce electricity. The mass of the spinning turbine and the coupled spinning generator provide inertia to a transmission system of the electrical grid. In the United States and Canada, for example, system inertia provided by rotating synchronous generators support a stable system frequency of ˜60 Hz.

In contrast, inverter-based resource (IBR) energy generators can generate power through the use of equipment that accesses renewable energy sources (e.g., wind turbines, solar panels, etc.). Unlike synchronous energy resources, the prime mover of renewable generation is decoupled from the electrical grid and is instead connected to the grid by power electronics inverters. These power electronics inverters convert the generated power (e.g., power generated through the movement of wind turbine blades, power generated through the collection of solar radiation by solar panels, etc.) into AC power that is supplied to the electrical grid. Since the AC current supplied to the electrical grid is decoupled from the prime mover of the renewable resources, they provide little to no inertia to the transmission system of the electrical grid.

Blackouts and/or brownouts can arise, often as accidents, when there is a fault in a transmission system of an electrical grid. In general, blackouts result in a loss of power to an area. Large blackouts can be caused by a series of events called a cascading failure. For example, if a fault occurs in an energy transmission line and the line trips (e.g., is disconnected from other transmission lines), then the failure of the faulted line can put additional stress on other lines in the system, and thus weaken the system as a whole. Faults in the energy transmission line can cause voltage and/or frequency swings across the system, which may increase stress on the system and may cause protective relays to trip additional lines in the system. Voltage and/or frequency swings may be dangerous to generator equipment and may cause protection devices to shut down power generation altogether. In general, brownouts result in a reduction of power to an area. Sometimes, brownouts can be performed deliberately by a utility provider to prevent blackouts, such as when there is an increase in power usage and/or when there is an overload on the system.

### SUMMARY

The document generally describes technology (e.g., systems, apparatuses, devices, controllers, circuitry, methods, techniques, etc.) for more accurate and precise tripping of energy loads during under-frequency events based on a supervised deceleration of a Rate of Change of Frequency (RoCoF), to more accurately, consistently, quickly, and reliably achieve a balance of load-generation in an electrical grid (e.g., re-establishing a target frequency value of 60 Hz in the electrical grid). For example, relays that solely rely on set points to shed differing loads can, in some instances, extend a load-generation imbalance by either shedding too much or too little load to adequately match a drop in generation, which can either extend the duration of an under-frequency event (e.g., when load is shed too slowly in response to the event), or can result in an over-frequency event in which the frequency overshoots a target frequency value (e.g., when load is shed too quickly). Both scenarios can be problematic and can potentially lead to broader problems throughout the electrical grid. The disclosed innovation is directed to controllers and corresponding circuitry that is able to appropriately respond to under-frequency events so that a sufficient amount of load is shed at appropriate timelines commensurate to the magnitude of the event, which can shorten the duration of under-frequency events and prevent potentially dangerous over-frequency events from occurring.

In general, the inertia associated with synchronous power generators that rely on turbines to generate electrical power (e.g., coal, oil, natural gas, nuclear, etc.), has historically provided for less fluctuation and greater consistency in the frequency of the provided electrical power. However, inverter-based energy sources, including renewable energy sources like solar and wind, and including battery energy storage systems (BESS), can have less associated inertia, which can lead to greater fluctuations in the frequency of electrical power that is supplied to the grid as these energy sources come online and/or go offline. As a result, higher penetrations of inverter-based energy sources within a grid (i.e., a greater proportion of inverter-based energy sources relative to synchronous energy sources) may result in greater susceptibility to significant frequency fluctuations, which in turn may result in tripping too little load or too much load during an energy system under-frequency event. Tripping too much energy load, for example, may in turn result in a severe over-frequency condition that may cause uncontrolled tripping of energy generation that results in cascading failure and system blackout.

In general, the disclosed technology can provide a proactive solution for monitoring and handling both under-frequency and over-frequency events, in order to prevent system blackouts and/or brownouts. For example, the disclosed technology provides controllers and circuitry to protect against under-frequency events, particularly when a greater susceptibility such events exists (e.g., when there is greater proportion of inverter-based energy sources relative to synchronous sources in an electrical grid). The disclosed technology is able to accomplish this by monitoring a RoCoF for the supplied power over time, and using the RoCoF in combination with frequency set points and timers to identify under-frequency events. Appropriate amounts of load can be automatically tripped to counteract the magnitude of the under-frequency event (i.e., more load for higher RoCoFs and less load for lower RoCoFs), which can be indicated by RoCoF derivations, including a supervised deceleration of the RoCoF over time. By using RoCoF calculations in combination with frequency set points and timers, appropriate amounts of load can be tripped with minimal or no time delay relative to circuitry that relies on set points alone. In particular, the disclosed technology can employ microprocessor relay frequency elements, timer elements, and set/reset latch elements as part of a relay control circuitry to monitor the RoCoF of supplied power, and to automatically trip loads in response to under-frequency events. The disclosed technology can be implemented, for example, in protective relays deployed and used in energy transmission systems, such as part of an under-frequency load shed (UFLS) program to reduce or otherwise eliminate system blackouts and/or brownouts as a result of a frequency disturbance.

One or more embodiments described herein can include a method for tripping energy loads in an energy transmission system based on Rate of Change of Frequency (RoCoF). The method can include detecting an initial RoCoF of electrical voltage in the energy transmission system; determining that the initial RoCoF falls within one of n predetermined frequency bands; in response to determining that the initial RoCoF falls within one of n predetermined frequency bands, arming an amount of energy load to trip that corresponds to the one of n predetermined frequency bands; after detecting the initial RoCoF, starting at least one tripping delay timer; while the at least one tripping delay timer is running, (i) detecting a deceleration RoCoF of electrical voltage in the energy transmission system, and (ii) detecting that a frequency of the electrical voltage has decayed past a tripping frequency threshold; in response to detecting that the frequency of the electrical voltage has decayed past the tripping frequency threshold, determining a time at which to trip the amount of energy load, based at least in part on the deceleration RoCoF of electrical voltage; and tripping the amount of energy load at the determined time.

One or more embodiments described herein can include a relay apparatus that can be configured to perform the method for tripping energy loads in an energy transmission system based on Rate of Change of Frequency (RoCoF). The relay apparatus can optionally include one or more of an initial RoCoF detector logic component; a secondary RoCoF deceleration detector logic component; a fast transient filter component; an under-voltage inhibitor logic component; a supervised under-frequency trip logic component; and a supervised automatic load restoration logic component configured to determine whether to restore the energy load by a predetermined amount.

Other embodiments of these aspects can include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The method can be performed by control circuitry of a relay of the energy transmission system. The amount of energy load to trip can be proportional to the initial RoCoF, according to the one of n predetermined frequency bands in which the initial RoCoF falls. Determining the time at which to trip the amount of energy load can include determining whether to extend the at least one tripping delay timer, or immediately trip the amount of energy load. Detecting the initial RoCoF of electrical voltage can include: detecting that the frequency of electrical voltage has decayed past a first frequency threshold; simultaneously starting a set of initial timers, with each consecutive initial timer of the set of initial timers being configured to assert after a progressively increasing initial timer interval has elapsed; after starting the set of initial timers, detecting that the frequency of electrical voltage has decayed past a second frequency threshold; in response to detecting that the frequency of electrical voltage has decayed past the second frequency threshold, determining which initial timers of the set of initial timers have asserted; and determining that the initial RoCoF has a value that corresponds to the initial timers of the set of initial timers that have asserted. The at least one tripping delay timer can include a set of tripping delay timers. Detecting the deceleration RoCoF of electrical voltage can include: in response to detecting that the frequency of electrical voltage has decayed past the second frequency threshold, simultaneously starting the set of tripping delay timers, with each consecutive tripping delay timer of the set of tripping delay timers being configured to assert after a progressively increasing tripping delay timer interval has elapsed; after starting the set of tripping delay timers, detecting that the frequency of electrical voltage has decayed past the tripping frequency threshold; in response to detecting that the frequency of electrical voltage has decayed past the tripping frequency threshold, determining which tripping delay timers of the set of tripping delay timers have asserted; and determining that the deceleration RoCoF has a value that corresponds to the tripping delay timers of the set of tripping delay timers that have asserted. Each tripping delay timer of the set of tripping delay timers can be paired with a corresponding initial timer of the set of initial timers, with the tripping delay timer being configured for use in detecting a deceleration RoCoF that is in the range of 50-75% of a lower bound of a predetermined frequency band that is associated with the corresponding initial timer. At least one simulation of an under-frequency event in the energy transmission system can be conducted. Based on results of the at least one simulation, optimized values can be determined for the n predetermined frequency bands, for the amounts of load to trip that correspond to the n predetermined frequency bands, and for the at least one tripping delay timer. Control circuitry of the energy transmission system can be reconfigured based on the optimized values. A change in capacity in the energy transmission system can be detected. The at least one simulation of the under-frequency event can be conducted in response to detecting the change in capacity.

The technology described herein may provide one or more of the following advantages. The disclosed technology can reduce, mitigate, or otherwise eliminate the occurrence of system-wide blackouts or brownouts. This can be achieved by monitoring RoCoF over time and tripping appropriate energy loads to avoid extended under-frequency events and over-frequency events. RoCoF can be used in combination with threshold set points, such as Level 1 (59.3 Hz), Level 2 (59.0 Hz) and Level 3 (58.7 Hz), to shed appropriate amounts of load to more quickly resume operations at a target frequency value (e.g., 60 Hz, or another target frequency value), thereby avoiding the overshooting or undershooting of load tripping, to maintain a grid frequency at the desired target frequency value. The disclosed technology can be implemented in existing transmission systems at a low cost. Further, the disclosed technology can save costs related to potential investments in synchronous condensers, to accomplish the same or similar objectives. Further, the disclosed technology can employ battery energy storage systems (BESS) that provide inertial and/or fast frequency response (FFR), thereby ensuring that a minimum amount of load is shed during a frequency excursion. Further, by delaying the time at which load tripping occurs, additional time can be provided to allow inverter-based energy sources (e.g., battery energy storage systems (BESS, etc.) to deliver power, thereby minimizing the amount of load to shed and stabilizing the energy transmission system at a target operating frequency more quickly. Further, the disclosed technology can reduce and/or eliminate the extent and severity of blackouts, which can prevent a loss of revenue, reduce the possibility of lawsuits, reduce the possibility of penalties and/or fines (e.g., fines/penalties from the North American Electric Reliability Corporation (NERC) or another regulatory authority), and reduce the potential for negative publicity.

The details of one or more implementations are set forth in the accompanying drawings and the description below. Other features and advantages will be apparent from the description and drawings, and from the claims.

### BRIEF DESCRIPTION OF THE DRAWINGS

FIGS. 1A-1B are conceptual diagrams of an electric power transmission system that employs a RoCoF under-frequency tripping scheme.

FIG. 2 is a conceptual block diagram of a RoCoF control circuitry of a relay for performing the disclosed techniques.

FIGS. 3A-3F depict an illustrative example of a RoCoF control circuitry of a relay for performing the disclosed techniques.

FIG. 4A illustrates example test results related to tripping energy loads with and without a RoCoF under-frequency tripping scheme.

FIG. 4B illustrates example data related to energy loads to be tripped with a RoCoF under-frequency tripping scheme.

FIG. 4C illustrates example test results related to conventional relay load shedding in response to under-frequency events, at varying ratios of synchronous and inverter-based resources.

FIG. 4D illustrates example test results related to a comparison between a RoCoF control circuitry and a conventional relay during an under-frequency event.

FIG. 5 is a flowchart of an example process for tripping energy loads using a RoCoF under-frequency tripping scheme.

FIG. 6 depicts an example illustrative process for performing simulations of under-frequency events, and applying configuration settings determined during the simulations to RoCoF control circuitry of relays.

FIG. 7 is a schematic diagram that shows an example of a computing system.

Like reference symbols in the various drawings indicate like elements.

### DETAILED DESCRIPTION OF ILLUSTRATIVE EMBODIMENTS

This document generally relates to technology that enables relays and other components to quickly, efficiently, and proportionally respond to under-frequency events based on the Rate of Change of Frequency (RoCoF) of the supplied energy. In particular, the disclosed technology can use RoCoF to shed appropriate energy loads on energy transmission systems in response to under-frequency events in a manner that avoids tripping too much or too little load. An under-frequency event can occur when a significant amount of energy generation is lost, which depending on the proportion of synchronous and inverter-based energy sources supplying the energy, can cause variation in the RoCoF during under-frequency events. When frequency decays quickly, more load than desired may trip. If too much load is tripped, then a target frequency may be overshot (e.g., the frequency may exceed 60 Hz), which can cause additional generation tripping and potential blackouts. The disclosed technology allows for the monitoring of the RoCoF, including a possible deceleration in the RoCoF over time, against one or more under-frequency level set points (e.g., thresholds) in order to optimize the amounts of loads tripped to avoid system-wide or large blackouts or brownouts. More load can be tripped at certain under-frequency level set points versus others to avoid massive changes in frequency that can impact other energy loads and generation across the system. Some renewable energy resources in an electrical grid may not be controllable, which can cause mismatches or inconsistencies in energy production and consumption on the grid. A RoCoF within the electrical grid can be assessed at relay locations across a system, to determine whether the RoCoF crosses various threshold level set points at various set times and if so, how much energy load to trip.

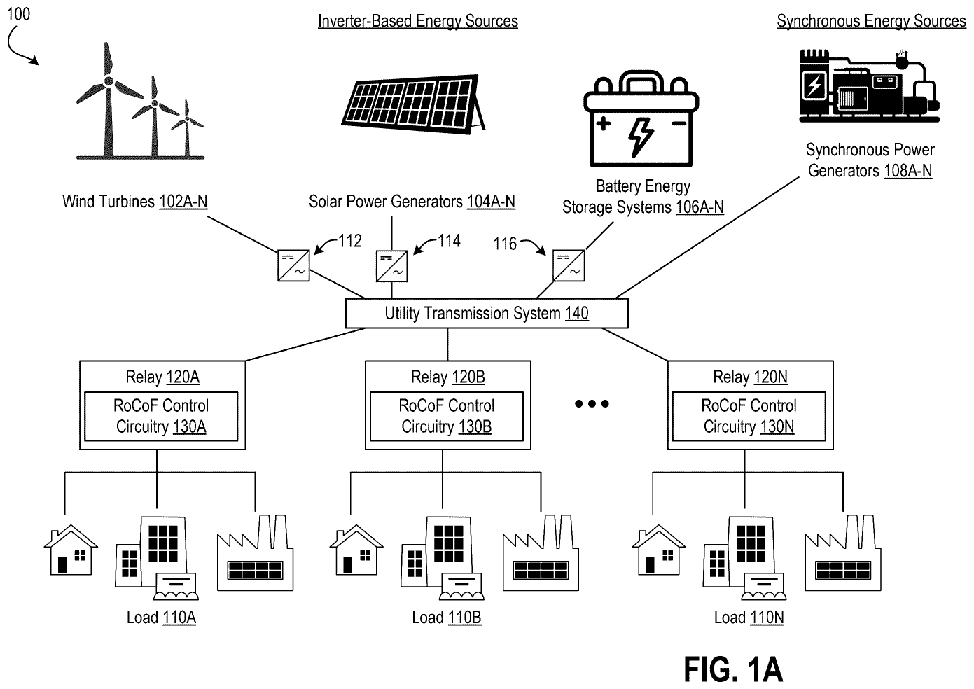

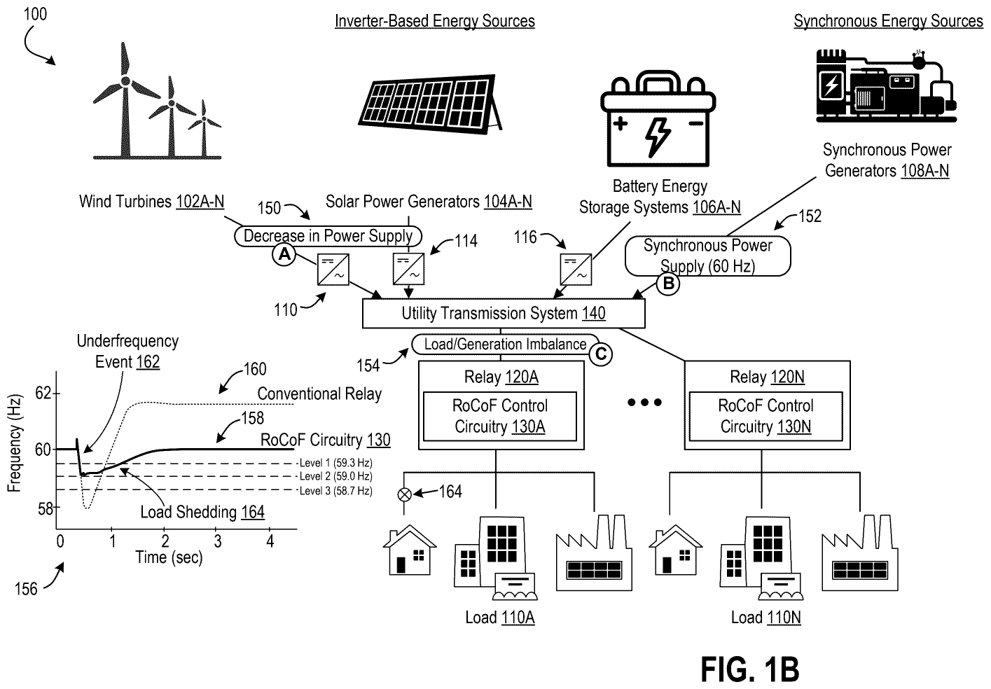

FIGS. 1A-1B are conceptual diagrams of an electric power transmission system 100 that employs a RoCoF under-frequency tripping scheme. Referring to FIG. 1A, various types of energy resources can provide energy to be consumed. Such energy resources can include inverter-based energy sources (e.g., wind turbines 102A-N, solar power generators 104A-N, battery energy storage systems (BESS) 106A-N, etc.), and synchronous energy sources, such as power plants 108A-N (e.g., coal, oil, natural gas, nuclear, etc.). The energy resources 102A-N, 104A-N, 106A-N, and/or 108A-N can generate energy to be provided via a utility transmission system 140 to various energy consumers, such as residential, commercial, and industrial energy consumers, which are represented as loads 110A-N. The energy can be routed to the different energy consumers from the utility transmission system 140 and monitored by relays 120A-N, each of which can have respective Rate of Change of Frequency (RoCoF) control circuitry 130A-N, with each of the control circuitry 130A-N possibly having the same or different control logic. Each of the relays 120A-N can be configured to monitor different loads 110A-N (e.g., buildings, homes, residential structures, stores, restaurants, and other energy consumers). The RoCoF control circuitry 130A-N of each of the relays 120A-N monitor RoCoF in the relay's domain/region and trip load based on the magnitude of RoCoF, thereby avoiding major blackouts across various domains in the system 100.

The relays 120A-N can, using the RoCoF control circuitry 130A-N, engage tripping schemes to counteract energy drops and spikes that may arise from variability in certain types of energy resources, such as wind and solar. For example, energy production from the wind turbines 102A-N and the solar power generators 104A-N may decrease (e.g., during calm days, during cloudy days), or increase (e.g., during windy days, during sunny days). In the present example, the wind turbines 102A-N, the solar power generators 104A-N, and various battery energy storage systems (BESS) 106A-N can rely on corresponding DC-to-AC inverters 112, 114, and 116 to supply electrical current at a target frequency (e.g., 60 Hz), and can have little-to-no inertial energy in comparison to turbine-based synchronous power generators 108A-N. Thus, the inverter-based energy sources 102A-N, 104A-N, and 106A-N may not be constant energy sources, whereas energy from the synchronous power generators 108A-N can have corresponding inertial energy that can provide electricity at more constant and/or predictable frequency. Variation can be introduced into the system as distributed inverter-based energy sources are added to or removed from the grid, such as through residential and commercial solar panels and/or wind turbines that can be associated with loads 110A-N. The disclosed technology can be used to counteract under-frequency events, particularly in situations where there is a greater proportion of inverter-based energy sources introducing greater potential variability in the frequency of the supplied power. Further, the disclosed technology can employ battery energy storage systems (BESS) that provide inertial and/or fast frequency response (FFR), thereby ensuring that a minimum amount of load is shed during a frequency excursion. The system 100 can be used to avoid causing blackouts or brownouts across the entire system 100 or large areas of the system 100, by automatically engaging tripping schemes at one or more of the relays 120A-N through the use of the RoCoF control circuitry 130A-N.

As an illustrative example of the disclosed techniques, significant amounts of renewable energy generation, such as wind and/or solar generation (e.g., wind turbines 102A-N, solar power generators 104A-N, etc.), may be added to the system 100. A prime mover of renewable generation can be decoupled electrically from a transmission grid, such as the utility transmission system 140. The prime mover can be connected to the transmission grid by power electronics inverters (e.g., inverters 112, 114). These power electronics inverters can convert movement of wind turbine blades and solar radiation absorbed by solar panels into alternating current (AC) that can then be injected into the utility transmission system 140 via the inverters. Since the AC current supplied to the system 140 is decoupled from the prime mover of the renewable resources, they provide little to no inertia to the system 140. Inertia in the system 140 can be provided by a rotating mass of conventional synchronous generators (e.g., synchronous power generators 108A-N) spinning at 3,600 revolutions per minute (rpm), or 60 revolutions per second (e.g., 60 Hz). These generators typically can be powered by coal, oil, natural gas, or nuclear fuel. When this fuel is burned, water can be heated in a boiler until it changes state to steam. The steam can then pass through a turbine that turns the generators to produce electricity. The mass of the spinning turbine and coupled spinning generator provide inertia to the system 140. System inertia provided by rotating synchronous generators can support a stable system frequency of approximately 60 Hz (or another suitable frequency for the particular system). Occasionally, a loss of generation suddenly may occur on the grid, which can create an imbalance of energy load and generation. When there is not enough generation to supply connected load, generators slow down, and the system frequency can drop below 60 Hz. If the system frequency drops below 59 Hz (e.g., 3,540 rpm), cumulative generator turbine blade damage can occur. To rebalance load and generation in such a scenario, energy load can be tripped.

The system frequency can typically be 60 Hz if energy load and generation are balanced (e.g., equal). If a change in energy load or generation occurs, the frequency may rise for loss of load, or drop for loss of generation. The equations below show the relationship of deviation from normal frequency for a change in load (negative DL) or generation (positive DL):

$$f = {f}_{sys} - Δ L \cdot ( 1 - {e}^{- \frac{t}{T}} ) \cdot K \cdot 60 \qquad ( 1 )$$

$$T = \frac{M}{D} K = \frac{1}{D}$$

where
   fₘ is the base system frequency (60 Hz),
   ΔL is the change in load in per unit,
   M is the inertia constant of the system, which equals 2H,
   D is the load-damping constant,
   60 is the constant to put the values in Hz.
   Rewriting the equation and substituting values for and K yields (2).

$$f = {f}_{sys} - Δ L \cdot ( 1 - {e}^{- \frac{D \cdot t}{2 \cdot H}} ) \cdot \frac{1}{D} \cdot 60 \qquad ( 2 )$$

Taking the first derivative of (2) yields (4) to calculate tie ROCOF at any point in time.

$$\frac{df}{dt} = \frac{- 30 \cdot Δ L}{H} \cdot {e}^{\frac{D \cdot t}{1 \cdot H}} \qquad ( 4 )$$

Solving the first derivative at t=0 yields (5) and results in the fastest ROCOF,

$$\frac{df}{dt} = \frac{- 30 \cdot Δ L}{H} \qquad ( 5 )$$

As shown in equations 4 and 5 above, the RoCoF may be directly proportional to the change in load and/or generation, and inversely proportional to inertia. As inertia decreases, for example, the RoCoF increases, whereas as inertia increases, the RoCoF decreases. Furthermore, increased renewable energy generation and decreased system inertia can result in deeper frequency excursions and excessively high final frequencies, which can lead to system-wide blackouts. Therefore, the disclosed techniques can be used to avoid such system-wide blackouts, by tripping loads by predetermined amounts based on assessment of RoCoF.

Referring to FIG. 1B, an illustrative example is given of an under-frequency event occurring in the electric power transmission system 100, and the RoCoF control circuitry 130A-N being used to quickly and efficiently shed appropriate amounts of load to respond to the event. In the illustrative example, there is a decrease in power supplied by the inverter-based energy sources 102A-N and/or 104A-N (step A, 150). At the same time, the synchronous power generators 108A-N, which have inertial mass that aids in maintaining a more consistent frequency, can supply energy at a target frequency (step B, 152). The greater the proportion of inverter-based energy that is supplied relative to the synchronous power supply and the greater the drop in inverter-based energy can cause a more significant load-generation imbalance, which can cause an under-frequency event to occur (step C, 154). As an illustrative example, a graph 156 is shown that depicts the occurrence of an example under-frequency event 162. A line 160 is shown for an example set point driven-response that is undertaken by a conventional relay (i.e., set points at Levels 1-3) and another line 154 is plotted for an example RoCoF control circuit 130 that additionally leverages RoCoF in order to shed loads. In the illustrative example, the RoCoF control circuit 130 is able to more quickly shed an appropriate load 164 based on the rate of change of the frequency drop in combination with the set points in order to better and more quickly regain the desired frequency of 60 Hz. In contrast, in the line 160 for a conventional relay, not enough load is initially shed at Level 1 or Level 2 to stop the fast drop in frequency, but because load is shed at predetermined levels quickly through Level 1, 2, and 3 set points, the sudden and significant reduction in the load ends up being too much, which creates an over-frequency event. The disclosed innovation embodied in the RoCoF control circuitry 130 described throughout this document is able to avoid such over-frequency events.

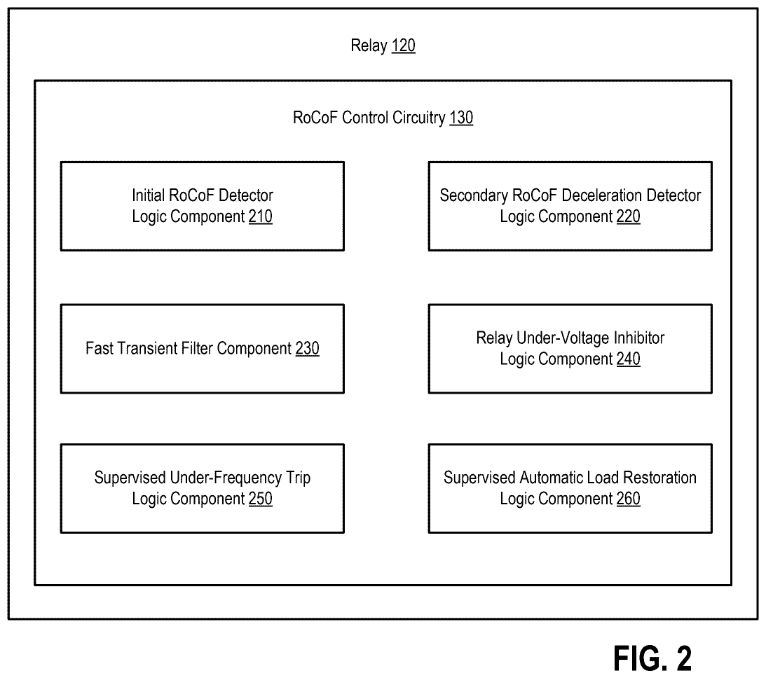

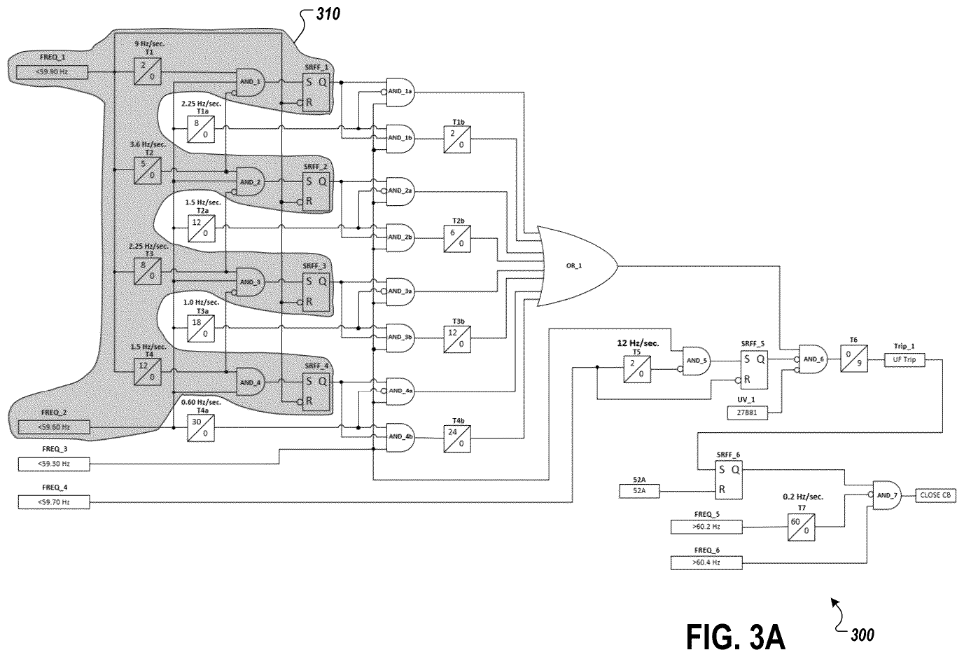

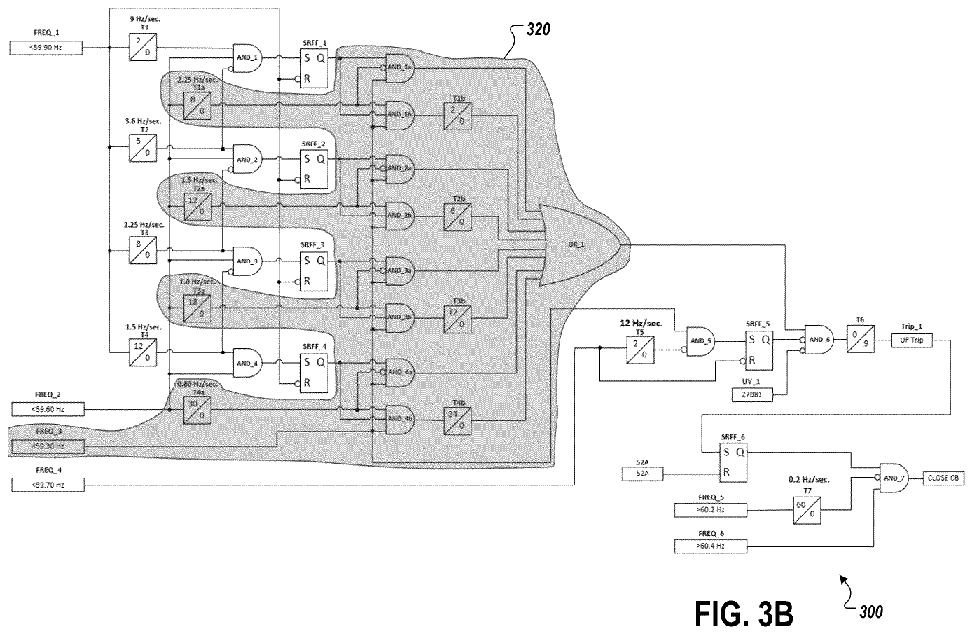

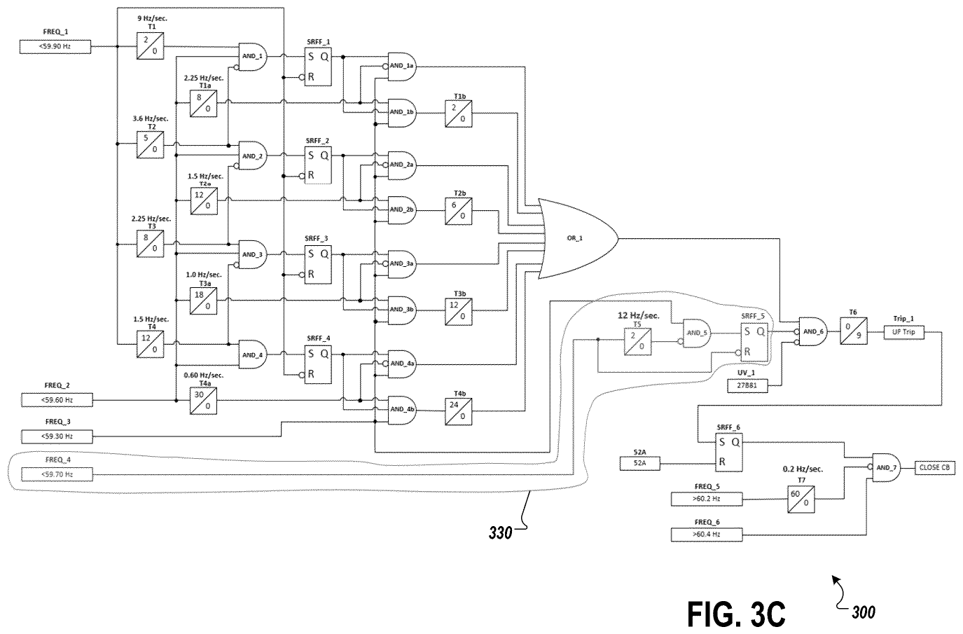

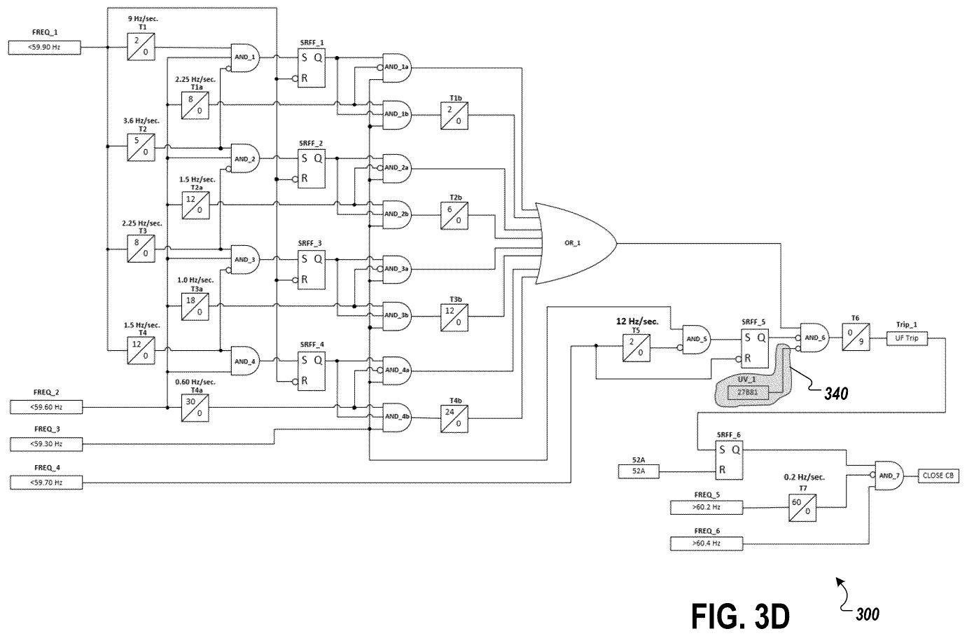

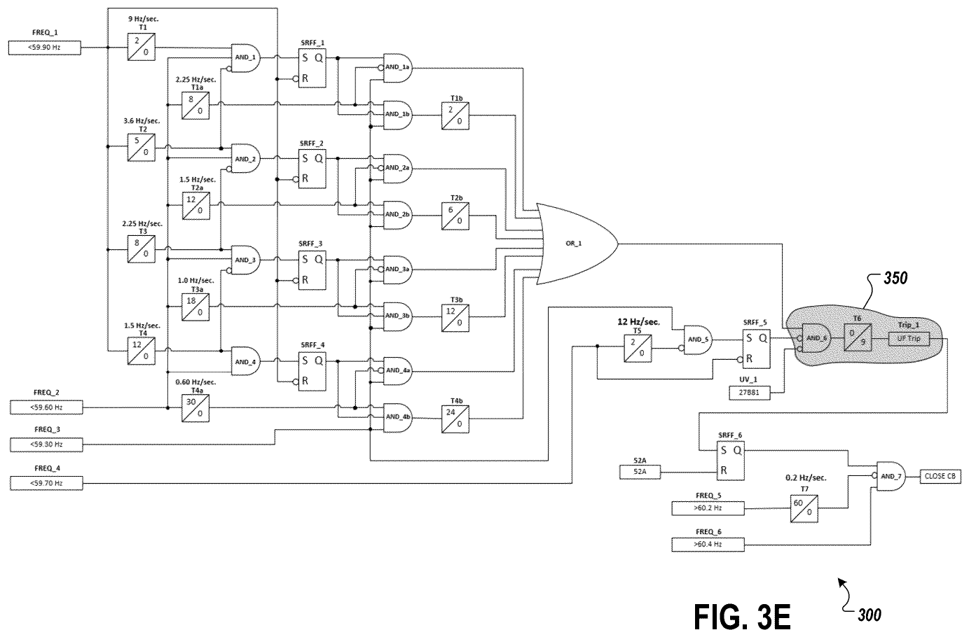

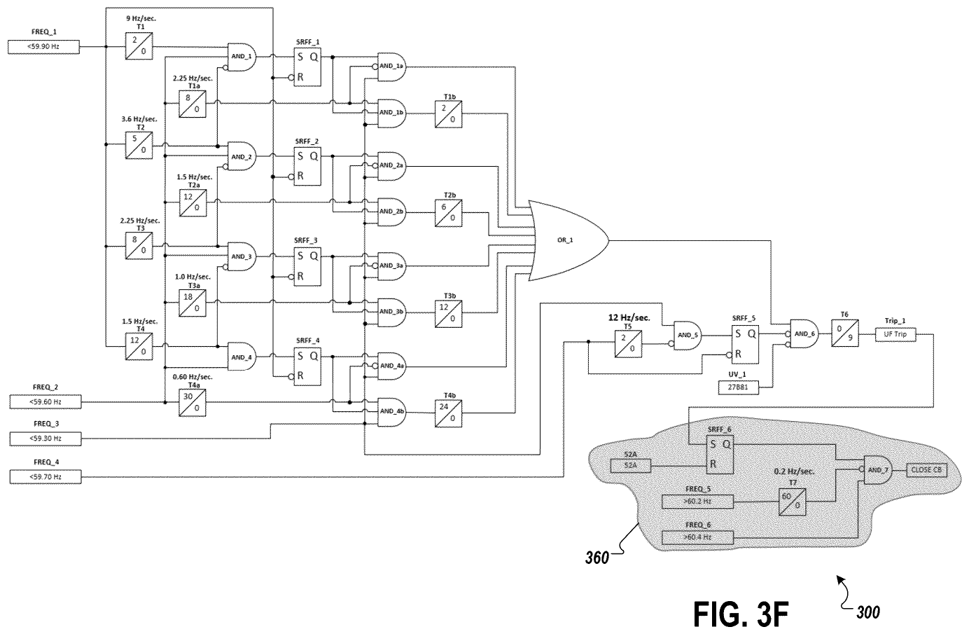

FIG. 2 is a conceptual block diagram of a RoCoF control circuitry of a relay for performing the disclosed techniques. In the present example, RoCoF control circuitry 130 (e.g., any of the circuitry 130A-N, shown in FIGS. 1A-1B) of a relay 120 (e.g., any of the relays 120A-N, also shown in FIGS. 1A-1B) includes an initial RoCoF detector logic component 210, a secondary RoCoF deceleration detector logic component 220, a fast transient filter component 230, a relay under-voltage inhibitor logic component 240, a supervised under-frequency trip logic component 250, and a supervised automatic load restoration logic component 260. In some implementations, the circuitry 130 may not include all of the components 210-260 and/or may include one or more additional components. For example, the supervised automatic load restoration logic component 260 can be an optional component of the circuitry 130 of the relay 120, that is implemented when system studies indicate that frequency overshoot may occur. In some implementations, one or more components may be built into or otherwise integrated into existing circuitry 130. For example, the relay under-voltage inhibitor logic component 240 can include logic that is built into the circuitry 130 of the relay 120. In general, information can be transmitted into and out of the RoCoF control circuitry 130 and the relay 120. For example, frequency signals can be transmitted to the circuitry 130 as described with reference to FIG. 1B. The frequency signals can be processed by one or more of the components 210-260, and the circuitry 130 can determine one or more controls based on the frequency processing. The controls can be transmitted out of the relay 120, and can include, for example, tripping/closing breakers in response to identifying under-frequency and/or over-frequency events using the components 210-260. Refer to FIGS. 3A-3F for further discussion related to each of the components 210-260.

FIGS. 3A-3F depict an illustrative example of a RoCoF control circuitry of a relay for performing the disclosed techniques. In the illustrative example, a logic diagram of RoCoF control circuitry 300 is shown (a possible implementation of the RoCoF control circuitry 130 of the relay 120, shown in FIG. 2), and operations of the circuitry 300 are described (including interactions between various components of the circuitry). For example, the control logic of the RoCoF control circuitry 300 can be implemented using microprocessor relays having custom control logic programming capabilities. However, other implementations for performing the control logic operations are possible (e.g., including hardware, software, or combinations thereof).

Similar to the RoCoF control circuitry 130 (shown in FIG. 2), the RoCoF control circuitry 300 of the present example includes various components that interact when executing a RoCoF under-frequency tripping scheme. FIG. 3A, for example, depicts an implementation of an initial RoCoF detector logic component 310 (e.g., similar to the initial RoCoF detector logic component 210, shown in FIG. 2). FIG. 3B, for example, depicts an implementation of a secondary RoCoF deceleration Detector Logic Component 320 (e.g., similar to the secondary RoCoF deceleration Detector Logic Component 220, shown in FIG. 2). FIG. 3C depicts an implementation of a fast transient filter component 330 (e.g., similar to the fast transient filter component 230, shown in FIG. 2). FIG. 3D depicts an implementation of a relay under-voltage inhibitor logic component 340 (e.g., similar to the relay under-voltage inhibitor logic component 240, shown in FIG. 2). FIG. 3E depicts an implementation of a supervised under-frequency trip logic component 350 (e.g., similar to the supervised under-frequency trip logic component 250, shown in FIG. 2). FIG. 3F depicts an implementation of a supervised automatic load restoration logic component 360 (e.g., similar to the supervised automatic load restoration logic component 260, shown in FIG. 2).

Referring to FIG. 3A, an illustrative example of the initial RoCoF detector logic component 310 is depicted. In the present example, the initial RoCoF detector logic component 310 can be a customizable component that includes various sub-components, including settable frequency detection elements (e.g., FREQ_1 and FREQ_2), timers (e.g., T1, T2, T3, and T4), AND gates (e.g., AND_1, AND_2, AND_3, and AND_4), and gated set-reset (SR) flip-flops (e.g., SRFF_1, SRFF_2, SRFF_3, and SRFF_4). Interactions between the various sub-components of the initial RoCoF detector logic component 310, for example, can serve to arm potential under-frequency tripping if an initial RoCoF is within a predetermined range (e.g., between 0-9 Hz/second or another suitable range).

In general, a selective tripping scheme can be implemented that allows for the potential tripping of a greater amount of load when high RoCoF is experienced, or a lesser amount of load when low RoCoF is experienced. For example, for level 1, 2, and 3 under-frequency tripping (e.g., 59.3 Hz, 59.0 Hz, 58.7 Hz, respectively), if an initial RoCoF is less than a first set point (e.g., 1.5 Hz/second, or when the RoCoF is in a band that ranges between 0-1.5 Hz/second), a corresponding first amount of system load may be tripped (e.g., 3.75%, or another suitable amount of load). This can be accomplished, for example, by arming the first amount of system load (e.g., 3.75%) to trip with all four SR flip-flops (e.g., SRFF_1, SRFF_2, SRFF_3, and SRFF_4). Continuing the present example, if the initial RoCoF is less than a second set point (e.g., 2.25 Hz/second, or when the RoCoF is in a band that ranges between 1.5-2.25 Hz/second), a corresponding second amount of system load may be tripped (e.g., 7.5%, or another suitable amount of load). This can be accomplished, for example, by arming an additional 3.75% of system load to trip with SRFF_1, SRFF_2 and SRFF_3. Continuing the present example, if the initial RoCoF is less than a third set point (e.g., 3.6 Hz/second, or when the RoCoF is in a band that ranges between 2.25-3.6 Hz/second), a corresponding third amount of system load may be tripped (e.g., 11.25%, or another suitable amount of load). This can be accomplished, for example, by arming an additional 3.75% of system load to trip with SRFF_1 and SRFF_2. Continuing the present example, if the initial RoCoF is less than a fourth set point (e.g., 9 Hz/sec, or when the RoCoF is in a band that ranges between 3.6-9 Hz/second), a corresponding fourth amount of system load may be tripped (e.g., 15%, or another suitable amount of load). This can be accomplished, for example, by arming an additional 3.75% of system load to trip with SRFF_1. To summarize the operations of the present example, SRFF_1 can supervise trip of 15%, SRFF_2 can supervise trip of 11.25%, SRFF_3 can supervise trip of 7.5%, and SRFF_4 can supervise trip of 3.75% of system load for under-frequency load shed levels 1, 2, and 3. During simulations, this staggered, balanced tripping of increasing levels of load for increasing levels of RoCoF has been observed to allow tripping of appropriate amounts of load, thereby facilitating more stable frequency recovery.

In general, a determination of an initial RoCoF can be implemented through the use of a coordinated set of timers which interact with the frequency detection elements to determine a frequency band in which the initial RoCoF is to be placed. For example, when system frequency reaches a first frequency value FREQ_1 (e.g., <59.9 Hz, or another suitable frequency value) for an under-frequency event, timers T1, T2, T3, and T4 assert simultaneously. If the initial RoCoF is less than a predetermined initial set point (e.g., 9 Hz/sec, or another suitable set point), for example, timer T1 will time out, asserting the top input to AND_1. In the present example, if the frequency then reaches a second frequency value FREQ_2 (e.g., <59.6 Hz, or another suitable frequency value) before timer T2 times out (e.g., indicating that the initial RoCoF is in a first frequency band that ranges between 3.6-9 Hz/second), all three inputs to AND_1 are asserted, which in turn asserts SRFF_1.

However, if timer T2 times out before FREQ_2 is reached, AND_1 is blocked and the top input to AND_2 is asserted. In the present example, if the frequency then reaches the second frequency value FREQ_2 before timer T3 times out (e.g., indicating that the initial RoCoF is in a second frequency band that ranges between 2.25-3.6 Hz/second), all three inputs to AND_2 are asserted, which in turn asserts SFRR_2.

If timer T3 times out before FREQ_2 is reached, AND_2 is blocked and the top input to AND_3 is asserted. In the present example, if the frequency then reaches the second frequency value FREQ_2 before timer T4 times out (e.g., indicating that the initial RoCoF is in a third frequency band that ranges between 1.5-2.25 Hz/second), all three inputs to AND_3 are asserted, which in turn asserts SRFF_3.

If timer T4 times out before FREQ_2 is reached, AND_3 is blocked and the top input to AND_4 is asserted. In the present example, when the frequency reaches the second frequency value FREQ_2 (e.g., indicating that the initial RoCoF is in a fourth frequency band that ranges between 0-1.5 Hz/second), both inputs to AND_4 are asserted, which asserts SRFF_4.

In the present example, once an amount of system load has been armed to potentially trip (e.g., via one or more of the SR flip-flops SRFF_1, SRFF_2, SRFF_3, and SRFF_4), the amount of system load can remain armed until a system frequency drops below a tripping frequency threshold (e.g., <59.3 Hz), or until the system frequency again rises above the first frequency value (e.g., 59.9 Hz) before dropping below the tripping frequency threshold. If the system frequency drops below the tripping frequency threshold, for example, a process for determining when to trip the armed amount of system load can start. If the system frequency again rises above the first frequency value before dropping below the tripping frequency threshold, for example, potential tripping of the armed amount of system load can be cancelled (e.g., by resetting the one or more SR flip-flops SRFF_1, SRFF_2, SRFF_3, and SRFF_4).

The logic shown in the present example can be for level 1 under-frequency tripping (e.g., 59.3 Hz). For level 2 under-frequency tripping (e.g., 59.0 Hz), FREQ_1 and FREQ_2 can be set to 59.6 Hz and 59.3 Hz (or other suitable values), respectfully, to maintain the same 0.3 Hz separation between FREQ_1 and FREQ_2. Similarly, for level 3 under-frequency tripping (e.g., 58.7 Hz), FREQ_1 and FREQ_2 can be set to 59.3 Hz and 59.0 Hz (or other suitable values), respectfully. The time delay selection for the various timers (e.g., timers T1, T2, T3, and T4) can be established based on system under-frequency load shed studies, for example. In general, such studies can be run under varying system inertia conditions (e.g., 20%-100% of maximum system inertia) and varying losses of generation (e.g., loss of 5%-50% of system peak load).

Referring to FIG. 3B, an illustrative example of the secondary RoCoF deceleration detector logic component 320 is depicted. In the present example, the secondary RoCoF deceleration detector logic component 320 can be a customizable component that includes a combination of a settable tripping frequency detection element (e.g., FREQ_3), and various other sub-components, including primary timers for tripping delay (e.g., T1a, T2a, T3a, and T4a), high-speed trip initiate AND gates (e.g., AND_1a, AND_2a, AND_3a, AND_4a), time-delayed trip initiate AND gates (e.g., AND_1b, AND_2b, AND_3b, AND_4b) and secondary timers for tripping delay (e.g., T1b, T2b, T3b, T4b). Interactions between the settable tripping frequency element and the various subcomponents of the secondary RoCoF deceleration detector logic component 320, for example, can serve to detect when a deceleration of a RoCoF occurs from an initial RoCoF. A deceleration from an initial RoCoF, for example, may occur as various inverter-based energy sources add power to the system 100 over time, in response to a drop in system frequency. For example, the wind turbines 102A-N (shown in FIGS. 1A-1B) may provide an inertial fast frequency in response to the drop in system frequency. As another example, the solar power generators 104A-N may have been withholding a percentage of potential power output, and can increase power output in response to the drop in system frequency. As another example, the battery energy storage systems (BESS) 106A-N can release power in response to the drop in system frequency. When a deceleration from the initial RoCoF is detected, for example, tripping of load can be further delayed, to provide additional time for the inverter-based energy sources to add power to the system 100.

In general, under-frequency tripping can be delayed until a tripping frequency FREQ_3 (e.g., <59.3 Hz, or another suitable tripping frequency that is less than FREQ_2 by 0.3 Hz, or another suitable value) is reached, and possibly for a period of time that extends beyond when the tripping frequency FREQ_3 is reached. For example, when system frequency reaches the second frequency value FREQ_2 (e.g., <59.60 Hz, or another suitable frequency value) for an under-frequency event, timers T1a, T1b, T1c and T1d assert simultaneously. If a deceleration RoCoF (e.g., the RoCoF that occurs after the secondary frequency value FREQ_2 is reached) is greater than a predetermined secondary set point (e.g., 2.25 Hz/second, or another suitable set point), for example, timer T1a will not time out, leaving the second input to AND_1a asserted. In the present example, if SRFF_1 is SET and the frequency reaches a third frequency value FREQ_3 (e.g., <59.3 Hz), all three inputs to AND_1a are asserted, which asserts OR_1. However, if the deceleration RoCoF is less than the predetermined secondary set point (e.g., 2.25 Hz/second), timer T1a will time out, blocking AND_1a and asserting the top input to AND_1b. If SRFF_1 is SET and the frequency reaches FREQ_3, all three inputs to AND_1b are asserted, which asserts timer T1b, which will then time out to assert OR_1.

If timer T2a does not time out (e.g., indicating a deceleration RoCoF being greater than 1.5 Hz/second but less than 2.25 Hz/second), the second input to AND_2a is asserted. If SRFF_2 is SET and the frequency reaches FREQ_3, all three inputs to AND_2a are asserted, which asserts OR_1. If timer T2a does time out (e.g., indicating a deceleration RoCoF of less than 1.5 Hz/second), timer T2a blocks AND_2a and asserts the top input to AND_2b. If SRFF_2 is SET and the frequency reaches FREQ_3, all three inputs to AND_2b are asserted, which asserts timer T2b, which will then time out to assert OR_1.

If timer T3a does not time out (e.g., indicating a deceleration RoCoF being greater than 1.0 Hz/second but less than 1.5 Hz/second), the second input to AND_3a is asserted. If SRFF_3 is SET and the frequency reaches FREQ_3, all three inputs to AND_3a are asserted, which asserts OR_1. If timer T3a does time out (e.g., indicating a deceleration RoCoF of less than 1.0 Hz/second), timer T3a blocks AND_3a and asserts the top input to AND_3b. If SRFF_3 is SET and the frequency reaches FREQ_3, all three inputs to AND_3b are asserted, which asserts timer T3b, which will then time out to assert OR_1.

If timer T4a does not time out (e.g., indicating a deceleration RoCoF being greater than 0.6 Hz/second but less than 1.0 Hz/second), the second input to AND_4a is asserted. If SRFF_4 is SET and the frequency reaches FREQ_3, all three inputs to AND_4a are asserted, which asserts OR_1. If timer T4a does time out (e.g., indicating a deceleration RoCoF of less than 0.6 Hz/second), timer T4a blocks AND_4a and asserts the top input to AND_4b. If SRFF_4 is SET and the frequency reaches FREQ_3, all three inputs to AND_4b are asserted, which asserts timer T4b, which will then time out to assert OR_1.

To disable the output of any SR flip-flop, the input from the pair of AND gates asserted by the SR flip-flop can be removed from the input to OR_1. For example, if it is desired to disable SRFF_4 so that a load will only trip when the RoCoF is within a specified range (e.g., between 1.5-9 Hz/second), the outputs of AND_4a and AND 4b can be removed from the input to OR_1. Alternatively, enable bits can be applied as inputs to AND_1, AND_2, AND_3 and AND_4 (not shown in logic diagram).

In general, a time delay selection for primary timers (e.g., timers T1a, T2a, T3a, and T4a) can be established based on a lower bound of each initial RoCoF bandwidth. For an initial RoCoF bandwidth of 3.6-9 Hz/second, for example, it is generally desirable to have a deceleration RoCoF of 50-75% of the lower bound of 3.6 Hz/second. For example, 62.5% of 3.6 Hz/second is 2.25 Hz/second. Thus, the corresponding timer setting for primary timer T1a in the present example is 0.3 Hz/2.25 Hz/second*60 cycles/second=8 cycles. This process can be repeated for the initial RoCoF bandwidths of 2.25-3.6 Hz/second and 1.5-2.25 Hz/second, for example. For the initial RoCoF bandwidth of 0-1.5 Hz/second, for example, a value of 25-75% of the RoCoF for timer T4 can be used. The various RoCoF bandwidths can be established based on under-frequency load shed studies to optimize performance.

Referring to FIG. 3C, an illustrative example of the fast transient filter component 330 is depicted. In general, the fast transient filter component 330 can provide an additional layer of security to avoid mis-tripping on a loss of transmission source (e.g., similar to the relay under-voltage inhibitor logic component 340 (UV_1), shown in FIG. 3D). If a loss of transmission source occurs at a substation with under-frequency relaying and loads that are mostly induction motors, for example, a motor load can hold the voltage above a UV_1 setting, and an under-frequency mis-trip may occur. The fast transient filter component 330, for example, can also provide transient protection from frequency anomalies (e.g., anomalies that may occur due to transmission faults around renewable power resources, such as wind turbines, solar power generators, etc.).

In the present example, the fast transient filter component 330 can detect a frequency drop at a fourth frequency value FREQ_4 (e.g., <59.7 Hz, or another suitable value). In response to detecting the frequency drop, for example, the fast transient filter component 330 can start adjustable timer T5 and can remove a reset state from flip-flop SRFF_5. The fourth frequency value FREQ_4, for example, can be an adjustable value that is generally higher than FREQ_3 (e.g., 0.4 Hz higher, or another suitably higher value), and that is not to exceed a predetermined transient frequency value that is less than a target frequency value for the system 100 (e.g., 59.8 Hz, or another suitable transient frequency value).

In the present example, if the frequency drops to FREQ_3 before timer T5 times out, AND_5 asserts to set flip-flop SRFF_5, which subsequently turns off AND_6, preventing underfrequency tripping. The fast transient filter component 330 in the present example can detect RoCoF above 12 Hz/second, with (59.7-59.3 Hz)/(2.0/60)=12 Hz/second. Timer T5 can be adjusted to a different value to change the detected RoCoF, for example, however the timer value is generally not to be set to less than two cycles. That is, if a true under-frequency event is experienced, the RoCoF will generally be less than 6 Hz/second. For such a true under-frequency event, for example, timer T5 will time out before FREQ_3 is reached and AND_5 will be blocked, allowing the middle input to AND_6 to remain armed due to no output from flip-flop SRFF_5. When the frequency recovers to above the transient frequency value (e.g., 59.7 Hz), for example, flip-flop SRFF_5 can be reset.

Referring to FIG. 3D, an illustrative example of the relay under-voltage inhibitor logic component 340 (UV_1) is depicted. In general, the relay under-voltage inhibit logic component 340 can ensure that under-frequency tripping does not occur unless the bus voltage is healthy, thus preventing under-frequency tripping for loss of source to a substation. The relay under-voltage inhibitor logic component 340, for example, can include the logic of built-in relay functions (e.g., SEL-351S, SEL-451, or other suitable protection systems). Normally, UV_1 is not asserted (logical 0), and the NOT bubble on AND_6 asserts, resulting in a logical 1 of that input to AND_6. If the monitored voltage drops below the UV_1 pick-up value (e.g., typically 67% of nominal voltage, and complying with Planning Coordinator's NERC PRC-006 Standard), for example, a logical 1 output of UV_1 results in a logical 0 to AND_6, which blocks AND_6, thus preventing under-frequency tripping.

Referring to FIG. 3E, an illustrative example of the supervised under-frequency trip logic component 350 is depicted. In general, the supervised under-frequency trip logic component 350 can combine the aforementioned logic components 310, 320, 330, and 340 into an under-frequency trip decision. If any of the inputs to OR_1 assert, and if SRFF_5 is not asserted and if UV_1 is not asserted, for example, AND_6 will assert timer T6, which can issue an under-frequency trip (Trip_1). Timer T6, for example, can maintain assertion of Trip_1 with its dropout timer (e.g., a 9-cycle timer, or another suitable value). Alternatively, conventional tripping logic can perform this task with secure unlatching logic.

Referring to FIG. 3F, an illustrative example of the supervised automatic load restoration logic component 360 is depicted. In general, the supervised automatic load restoration logic component 360 can be optional, and can be included in the RoCoF control circuitry 300 if frequency overshoot can potentially exceed an overshoot value (e.g., greater than 60.5 Hz, or another suitable overshoot value as determined by system studies). In the present example, load from level 1 (59.3 Hz) can be restored, with total load restoration being up to 5% of system load in multiple load blocks, and with no more than 2% of system load being restored in a single block. Load restoration can occur, for example, if the RoCoF is above 0.2 Hz/second, or another suitable value.

In the present example, the automatic load restoration logic can be asserted by an under-frequency trip (Trip_1). For example, Trip_1 can set SR flip-flop SRFF_6 when a circuit breaker has opened its contacts (e.g., when 52A becomes logical 0), removing a reset condition from SRFF_6. The assertion of SRFF_6 can be held for a first number of cycles (e.g., 9-cycles) by the dropout timer of timer T6. The breaker 52A opens (logical 0) within a second number of cycles that is less than the first number of cycles (e.g., 3-5 cycles, giving at least a 4-cycle margin). SRFF_6 can assert the top input to AND_7 and can be held until the circuit breaker closes and 52A resets SRFF_6. The middle input to AND_7 asserts when the frequency overshoots to a fifth frequency value FREQ_5 (e.g., 60.2 Hz). When FREQ_5 occurs, for example, adjustable timer T7 is started. If the frequency reaches a sixth frequency value FREQ_6 (e.g., 60.4 Hz) before timer T7 times out, Close CB asserts, which closes the circuit breaker, thus restoring load. In the present example, several cycles (e.g., approximately 3-5 cycles) after Close CB asserts, 52A asserts, resetting SR flip-flop SRFF_6. If timer T7 times out before the frequency value reaches FREQ_6, AND_7 is reset and no load restoration occurs. Timer T7 can be adjusted to a different value to reflect a different RoCoF, however the timer is generally not to be set to less than two cycles.

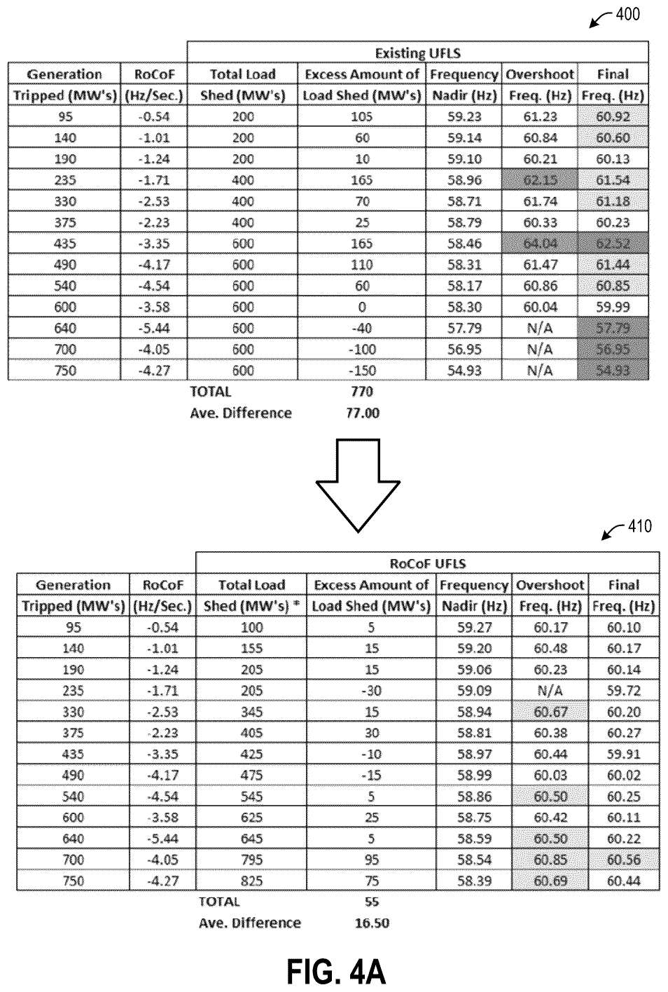

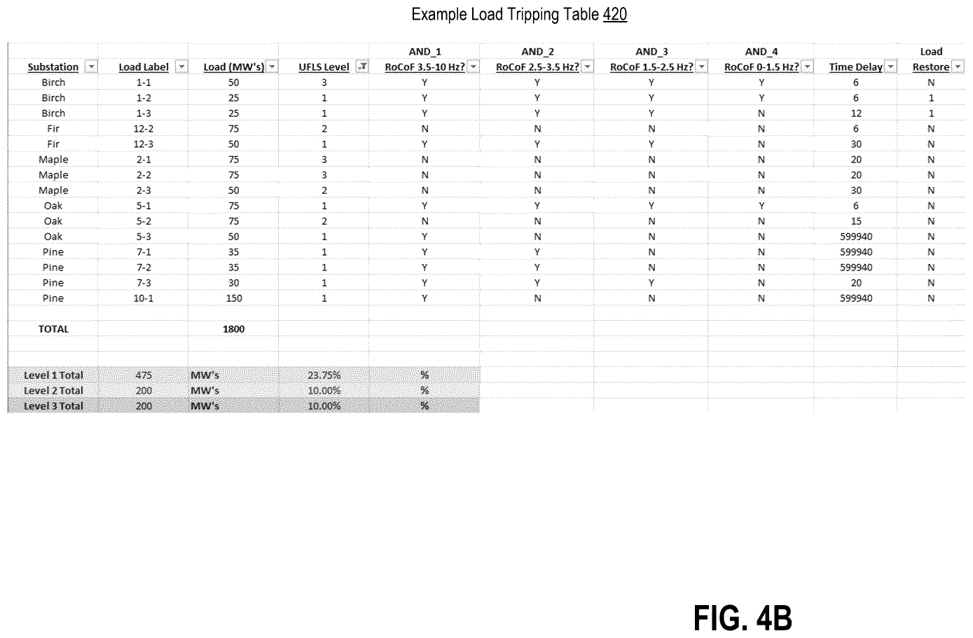

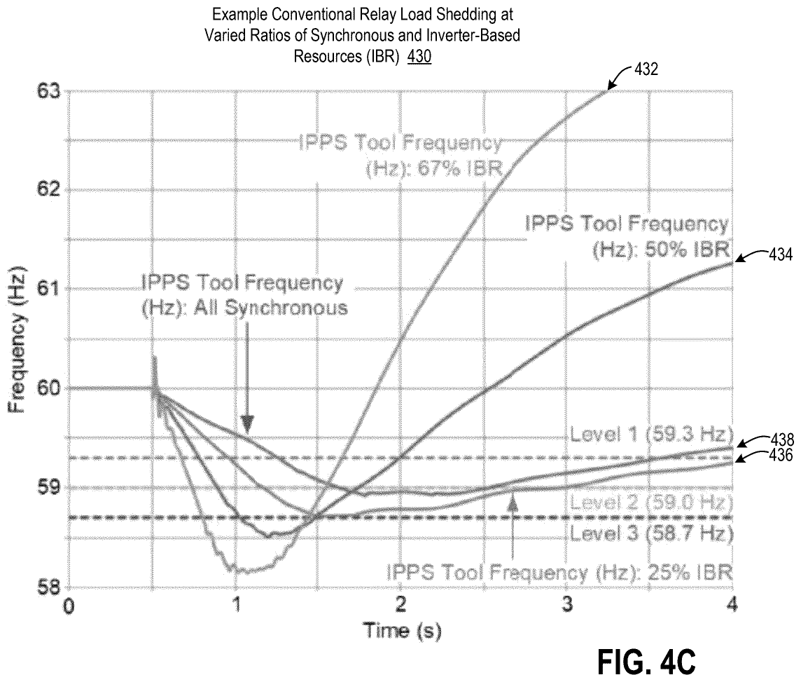

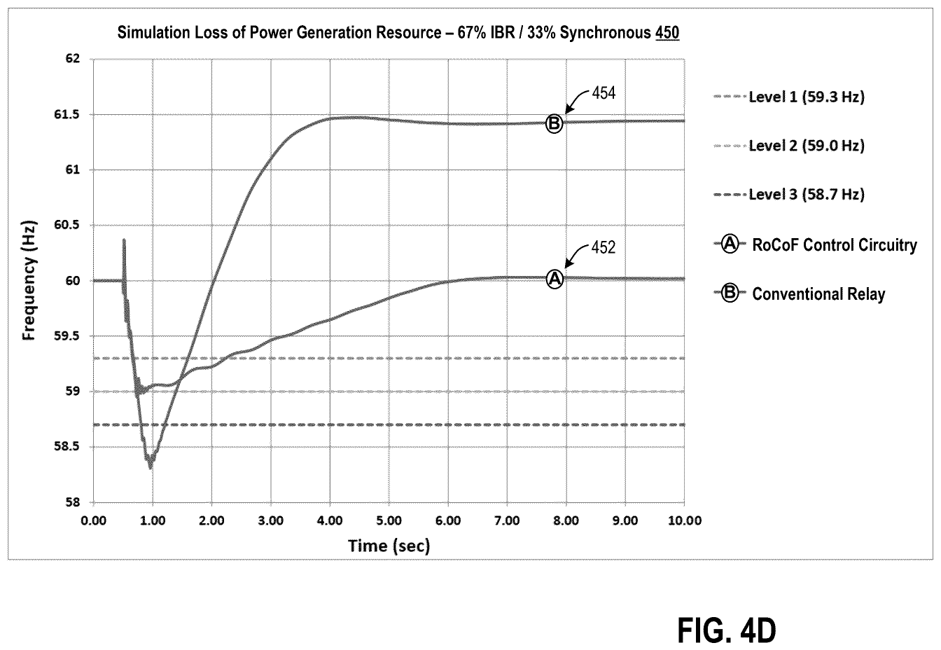

FIG. 4A illustrates example test results related to tripping energy loads with and without a RoCoF under-frequency tripping scheme. Table 400 displays example data related to tripping energy loads without the RoCoF under-frequency tripping scheme. Table 410 displays example data related to tripping energy loads with the RoCoF under-frequency tripping scheme described herein. For systems with high penetrations of wind and/or solar (which results in reduced system inertia), for example, RoCoF can generally be higher than normal. High RoCoF can result in too much load being tripped for system under-frequency events, which can in turn result in excessively high frequency, which can in turn lead to a system-wide blackout. A 67% reduced inertia test system caused by replacement of synchronous generation with type IV wind generation, for example, can highlight this effect. Test system study results, as shown in the example table 400, can be a scaled-down system that represents an existing energy transmission system. As shown in the table 400, for example, 5/13 (38%) of cases indicate that frequency is too high (in two cases) or too low (in three cases) to avoid system-wide blackout (which are shown in darkened boxes in the table 400). Average excess amount of load shed is 77 MW's in the example of the table 400. As shown in the table 410, where the described RoCoF under-frequency tripping scheme with transient filter supervision and automatic load restoration is used, no cases result in system-wide blackout and average excess amount of load shed is reduced to only 16.5 MW's.

FIG. 4B illustrates example data related to energy loads to be tripped with a RoCoF under-frequency tripping scheme. As shown by table 420, for example, more load can be tripped at level 1 than at levels 2 or 3. For example, up to 25% of load can be tripped at level 1, with a minimum of 10% of load being tripped at this level. At both levels 2 and 3, 10% of load may be tripped. In some implementations, the amount of load tripped at one or more levels can vary depending on the loads, expected frequency of a particular system, etc. In the illustrative example shown in the table 420, 205 MW of level 1 load was tripped (e.g., 10.25%) when the RoCoF was determined (e.g., using the disclosed techniques), to be less than 1.5 Hz/sec (refer to “AND_4” column in the table 420). As another example, 205 MW of level 1 load was tripped (10.25%) when the RoCoF was determined to be between 1.5 Hz/sec and 2.5 Hz/sec (refer to “AND_3” column in the table 420). As yet another example, 275 MW of level 1 load was tripped (13.75%) when the RoCoF was determined to be between 2.5 Hz/sec and 3.5 Hz/sec (refer to “AND_2” column in the table 420). Further, 475 MW of level 1 load was tripped (23.75%) when the RoCoF was determined to be between 3.5 Hz/sec and 10 Hz/sec (refer to “AND 1” column in the table 420).

FIG. 4C illustrates example test results related to conventional relay load shedding in response to under-frequency events, at varying ratios of synchronous and inverter-based resources (e.g., as represented by lines 432, 434, 436, and 438 of graph 430). Line 432 depicts an example under-frequency event occurring with a proportion of 67% inverter-based energy and 33% synchronous-based energy generation. Line 434 depicts an example under-frequency event occurring with a proportion of 50% inverter-based energy and 50% synchronous-based energy generation. Line 436 depicts an example under-frequency event occurring with a proportion of 25% inverter-based energy and 75% synchronous-based energy generation. Line 438 depicts an example under-frequency event occurring with a proportion of 0% inverter-based energy and 100% synchronous-based energy generation. As shown in these example lines 432-438, the greater the proportion of inverter-based energy during an under-frequency event, the worse the response from the conventional relay to the event.

FIG. 4D illustrates example test results related to a comparison between a RoCoF control circuitry and a conventional relay during an under-frequency event. For example, graph 450 shows an example comparison of a RoCoF control circuitry 452 and a conventional relay 454 during an under-frequency event. In the present example, the RoCoF control circuitry 452 is able to more quickly shed an appropriate amount of load to mitigate the under-frequency event and to regain a target frequency (e.g., 60 Hz), while at the same time avoiding the over-frequency event that can occur with conventional set-point based responses to under-frequency events (e.g., as performed by the conventional relay 454).

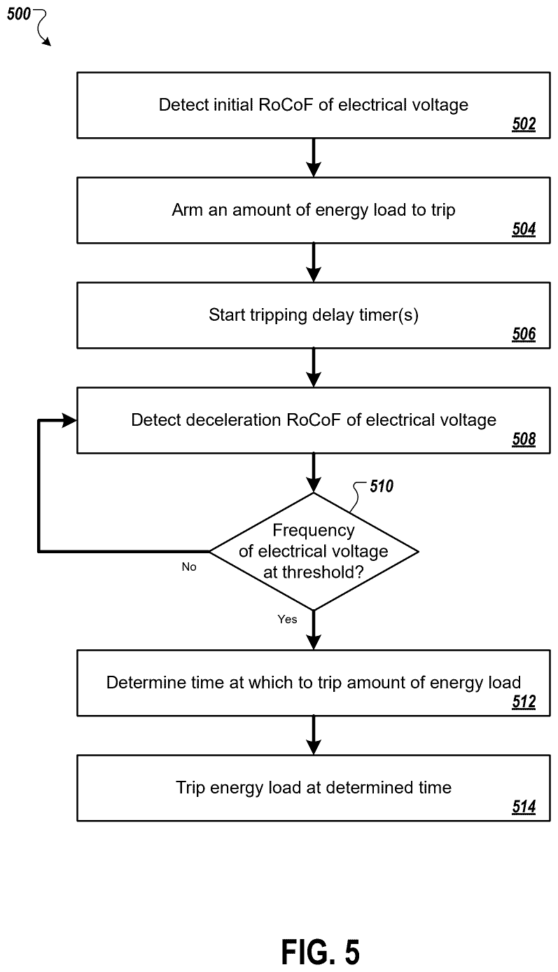

FIG. 5 is a flowchart of an example process 500 for tripping energy loads using a RoCoF under-frequency tripping scheme. The process 500, for example, can be performed by any of the RoCoF control circuitry described throughout this disclosure (e.g., refer to FIGS. 1A-1B, FIG. 2, and FIGS. 3A-3F), and/or by one or more other systems, devices, and/or components. In some implementations, the process 500 can be performed by software platforms that can be deployed at one or more computing systems, computing devices, cloud-based systems, and/or networks of computing systems and/or devices. For illustrative purposes, the process 500 is described from the perspective of a RoCoF control circuitry.

At 502, an initial RoCoF of electrical voltage is detected. Referring to FIG. 3A, for example, the RoCoF control circuitry 300 can use the initial RoCoF detector logic component 310 to detect the initial RoCoF of electrical volgate in an energy transmission system (e.g., the electric power transmission system 100, shown in FIGS. 1A-1B). For example, the system 100 can experience a sudden drop in energy production capacity, as one or more inverter-based (e.g., wind turbines 102A-N, solar power generators 104A-N, battery energy storage systems 106A-N) and/or synchronous energy sources (e.g., synchronous power generators 108A-N) fail or otherwise become disconnected from the system 100. In the present example, the drop in energy production capacity can cause a corresponding drop in system frequency as the current amount of energy production is insufficient to service the current amount of load 110A-110N, and the frequency of the various generators begins to slow down.

In some implementations, detecting an initial RoCoF of electrical voltage can be accomplished using frequency detection elements and initial timers. Referring to the present example of FIG. 3A, the initial RoCoF detector logic component 310 of the RoCoF control circuitry includes the settable frequency detection elements FREQ_1 (e.g., configured to detect when the system frequency drops below a first settable frequency threshold of 59.9 Hz) and FREQ_2 (e.g., configured to detect when the system frequency drops below a second settable frequency threshold of 59.6 Hz), and the set of initial timers T1, T2, T3, and T4. Other examples may be configured to include different settable frequency thresholds, more or fewer initial timers, and/or different timer values.

In the present example, FREQ_1 can be configured to detect when the frequency of the system 100 drops from a target operating frequency (e.g., 60 Hz) and decays past the first settable frequency threshold (e.g., <59.9 Hz), indicating a beginning of a possible under-frequency event. In response to detecting that the system frequency has decayed past the first settable frequency threshold, for example, the RoCof control circuitry 300 can simultaneously start the set of initial timers (e.g., T1, T2, T3, and T4). Each consecutive initial timer of the set of initial timers can be configured to assert after a progressively increasing initial timer interval has elapsed. For example, T1 can be configured to assert after two cycles have occurred (e.g., after approximately 0.033 seconds), T2 can be configured to assert after five cycles have occurred (e.g., after approximately 0.083 seconds), T3 can be configured to assert after eight cycles have occurred (e.g., after approximately 0.133 seconds), and T4 can be configured to assert after twelve cycles have occurred (e.g., after approximately 0.2 seconds).

Continuing the present example, after starting the set of initial timers (e.g., T1, T2, T3, and T4), the RoCoF control circuitry 300 can detect that the frequency of electrical voltage has decayed past the second frequency threshold, indicating that the possible under-frequency event has continued to develop. For example, FREQ_2 can be configured to detect when the frequency of the system 100 drops further, and decays past the second settable frequency threshold (e.g., <59.6 Hz). In response to detecting that the frequency of electrical voltage has decayed past the second frequency threshold, for example, the initial RoCoF detector logic component 310 of the RoCoF control circuitry 300 can determine which initial timers of the set of initial timers have asserted. In the present example, as time elapses from the time at which the set of initial timers T1, T2, T3, and T4 were initially started, each consecutive timer in the set can consecutively assert, thereby providing an input to a corresponding AND gate (e.g., AND_1, AND_2, AND_3, and AND_4), and thereby blocking an AND gate that corresponds to a previous initial timer (if applicable). The AND gates of the present example can serve to determine which of the initial timers T1, T2, T3, and T4 have asserted at the time at which FREQ_2 detects that the frequency of the system 100 has decayed past the second settable frequency threshold.

Continuing the present example, the RoCoF control circuitry 300 can determine that the initial RoCoF has a value that corresponds to the initial timers of the set of initial timers that have asserted. As described with respect to FIG. 3A, for example, by determining which timers have already expired (i.e., timed out) at the time at which the second settable frequency threshold has been decayed past, the RoFoC control circuitry 300 can determine that the initial RoCoF falls within one of n predetermined frequency bands. In the present example, if only the initial timer T1 has expired, the initial RoCoF is determined as having a value of between 3.6-9 Hz/second; if the initial timers T1 and T2 have expired, the initial RoCoF is determined as having a value of between 2.25-3.6 Hz/second; if the initial timers T1, T2, and T3 have expired, the initial RoCoF is determined as having a value of between 1.5-2.25 Hz/second, and if all initial timers T1, T2, T3, and T4 have expired, the initial RoCoF is determined as having a value between 0-1.5 Hz/second. It will be appreciated that with more timers, finer-grained frequency bands can be determined, whereas with fewer times, coarser-grained frequency bands can be determined. As another example, a single timer can be started when the system frequency decays past the first frequency threshold and stopped when the system frequency decays past the second frequency threshold, and an absolute initial RoCoF can be determined based on the frequency threshold values and the amount of time indicated by the single timer (e.g., by dividing the frequency change by the amount of elapsed time).

At 504, an amount of energy load to trip is armed. In general, the amount of energy load to trip can be proportional to the initial RoCoF, with a greater initial RoCoF indicating a greater amount of energy load to trip, and with a lesser initial RoCoF indicating a lesser amount of energy load to trip. Referring again to FIG. 3A, for example, in response to determining that the initial RoCoF falls within one of n predetermined frequency bands, the RoCoF control circuitry 300 can use the initial RoCoF detector logic component 310 to arm an amount of energy load to trip that corresponds to the one of n predetermined frequency bands. In the present example, if the initial RoCoF falls within a frequency band of between 3.6-9 Hz/sec, 15% of the energy load can be armed to trip; if the initial RoCoF falls within a frequency band of between 2.25-3.60 Hz/second, 11.25% of the energy load can be armed to trip; if the initial RoCoF falls within a frequency band of between 1.5-2.25 Hz/second, 7.5% of the energy load can be armed to trip, and if the initial RoCoF falls within a frequency band of 0-1.5 Hz/second, 3.75% of the energy load can be armed to trip. In the present example, arming an amount of energy load to trip can be accomplished through triggering an SR flip-flop (e.g., one or more of SRFF_1, SRFF_2, SRFF_3, and SRFF_4) that corresponds to a frequency band and to the amount of energy load. In other examples, other mechanisms (e.g., setting values in computer memory, etc.) can be used to arm energy load to trip.

At 506, one or more tripping delay timers are started. Referring now to FIG. 3B, in the present example, the secondary RoCoF deceleration detector logic component 320 of the RoCoF control circuitry 300 includes the set of primary timers for tripping delay (e.g., T1a, T2a, T3a, and T4a), and the set of secondary timers for tripping delay (e.g., T1b, T2b, T3b, T4b). Other examples may be configured to include more or fewer timers for tripping delay, and/or different timer values. In the present example, after the initial RoCoF has been detected (e.g., in response to FREQ_2 detecting that the second frequency threshold has been decayed past), the RoCoF control circuitry 300 can simultaneously start the set of primary timers for tripping delay T1a, T2a, T3a, and T4a. Similar to the set of initial timers T1, T2, T3, and T4, for example, each consecutive tripping delay timer of the set of tripping delay timers can be configured to assert after a progressively increasing tripping delay timer interval has elapsed. For example, T1a can be configured to assert after eight cycles have occurred (e.g., after approximately 0.133 seconds), T2a can be configured to assert after twelve cycles have occurred (e.g., after approximately 0.2 seconds), T3a can be configured to assert after eighteen cycles have occurred (e.g., after approximately 0.3 seconds), and T4a can be configured to assert after thirty cycles have occurred (e.g., after approximately 0.5 seconds).

At 508, a deceleration RoCoF of electrical voltage is detected. For example, while the at least one tripping delay timer is running, the RoCoF control circuitry 300 can use the secondary RoCoF deceleration detector logic component 320 to detect a deceleration RoCoF of electrical voltage in the electric power transmission system 100. In general, such a deceleration of RoCoF may be attributable to various inverter-based energy sources adding power to the system 100 over time, in response to the initial drop in system frequency.

In the present example, after starting the set of primary timers for tripping delay (e.g., T1a, T2a, T3a, and T4a), the RoCoF control circuitry can continually monitor for the frequency of electrical voltage potentially decaying past the tripping frequency threshold (e.g., using FREQ_3), while the timers continue to run and progressively expire (i.e., time out). At 510, a determination is performed of whether a frequency of electrical voltage has decayed past the tripping frequency threshold (e.g., <59.3 Hz), indicating that the system frequency has continued to drop beyond the second frequency threshold, and that at least some load is to be tripped (e.g., subject to other system conditions). If the frequency of electrical voltage has not yet decayed past the tripping frequency threshold, the process 500 can continue at 508, where the primary timer(s) for tripping delay continue to run, and a deceleration of RoCoF of electrical voltage is continually monitored.

In some implementations, detecting a deceleration RoCoF of electrical voltage can be accomplished using a tripping frequency detection element and tripping delay timers. For example, FREQ_3 can be configured to detect when system frequency falls below a settable tripping frequency (e.g., 59.3 Hz, or another suitable value based on system simulations). After the set of primary timers for tripping delay (e.g., T1a, T2a, T3a, and T4a) have been started, for example, the RoCoF circuitry 300 can detect when the frequency of the system 100 decays past a tripping frequency threshold indicated by FREQ_3. In response to detecting that the frequency of electrical voltage has decayed past the tripping frequency threshold, for example, the secondary RoCoF deceleration detector logic component 320 can determine which tripping delay timers of the set of tripping delay timers have asserted (e.g., using a set of AND gates corresponding to the tripping delay timers).

Continuing the present example, the RoCoF control circuitry 300 can determine that the deceleration RoCoF has a value that corresponds to the tripping delay timers of the set of tripping delay timers that have asserted. As described with respect to FIG. 3B, for example, by determining which timers have already expired (i.e., timed out) at the time at which the tripping frequency threshold has been decayed past, the RoCoF control circuitry 300 can determine that the deceleration RoCoF falls within a particular deceleration frequency band. In the present example, if only the primary timer T1a has expired, the deceleration RoCoF is determined as having a value of between 1.5-2.25 Hz/second; if the primary timers T1a and T2a have expired, the deceleration RoCoF is determined as having a value of between 1.0-1.5 Hz/second; if the primary timers T1a, T2a, and T3a have expired, the deceleration RoCoF is determined as having a value of between 0.6-1.0 Hz/second, and if all primary timers T1a, T2a, T3a, and T4a have expired, the deceleration RoCoF is determined as having a value between 0-0.6 Hz/second. It will be appreciated that with more timers, finer-grained deceleration frequency bands can be determined, whereas with fewer timers, coarser-grained deceleration frequency bands can be determined. As another example, a single tripping delay timer can be started when the system frequency decays past the second frequency threshold and stopped when the system frequency decays past the tripping frequency threshold, and an absolute deceleration RoCoF can be determined based on the frequency threshold values and the amount of time indicated by the single timer (e.g., by dividing the frequency change by the amount of elapsed time).

In some implementations, each tripping delay timer of the set of tripping delay timers is paired with a corresponding initial timer of the set of initial timers, with the tripping delay timer being configured for use in detecting a deceleration RoCoF that is in the range of 50-75% of a lower bound of a predetermined frequency band that is associated with the corresponding initial timer. For example, tripping delay timer T1a can be paired with initial timer T1, tripping delay timer T2a can be paired with initial timer T2, tripping delay timer T3a can be paired with initial timer T3, and tripping delay timer T4a can be paired with T4. As described with respect to FIG. 3B, a time delay selection for primary timers (e.g., timers T1a, T2a, T3a, and T4a) can be established based on a lower bound of each initial RoCoF bandwidth.

If the frequency of electrical voltage has decayed past the tripping frequency threshold, the process 500 can continue at 512, where a time at which to trip the amount of energy load is determined. For example, in response to detecting that the frequency of the electrical voltage has decayed past the tripping frequency threshold indicated by FREQ_3, the RoCoF control circuitry 300 can determine the deceleration RoCoF (e.g., a range value or an absolute value), and can determine a time at which to trip the armed amount of energy load, based at least in part on the deceleration RoCoF. In some implementations, determining the time at which to trip the amount of energy load can include determining whether to extend the at least one tripping delay timer, or immediately trip the armed amount of energy load. For example, if the deceleration RoCoF meets or exceeds an expected deceleration RoCoF value (e.g., is within a 50-75% range of a lower bound of an initial RoCoF for the under-frequency event), the armed amount of energy load can be tripped immediately, whereas if the deceleration RoCoF is under the expected RoCoF value, an additional tripping delay timer can be set (e.g., one of the secondary timers for tripping delay T1b, T2b, T3b, T4b), and the load tripping can occur after the additional tripping delay timer has elapsed. By delaying a time at which the load tripping occurs (e.g., through the primary and secondary tripping delay timers), additional time can be provided to allow inverter-based energy sources (e.g., the wind turbines 102A-N, the solar power generators 104A-N, and the battery energy storage systems (BESS) 106A-N) to deliver power, thereby minimizing an amount of load to shed and stabilizing the energy transmission system 100 at a target operating frequency (e.g., 60 Hz) more quickly.

At 514, the energy load can be tripped at the determined time. For example, the RoCoF control circuitry 300 can use the supervised under-frequency trip logic component 350 (shown in FIG. 3E) to trip the armed amount of load (e.g., the amount determined at 504), at the determined time (e.g., the time determined at 512). In some implementations, a final decision of whether to trip a load can be based at least in part on input from additional logic components. For example, the under-frequency trip logic component 350 of the control circuitry can receive additional input from the fast transient filter component 330 and the relay under-voltage inhibit logic component 340, and can generate a final trip decision based at least in part on the additional input.

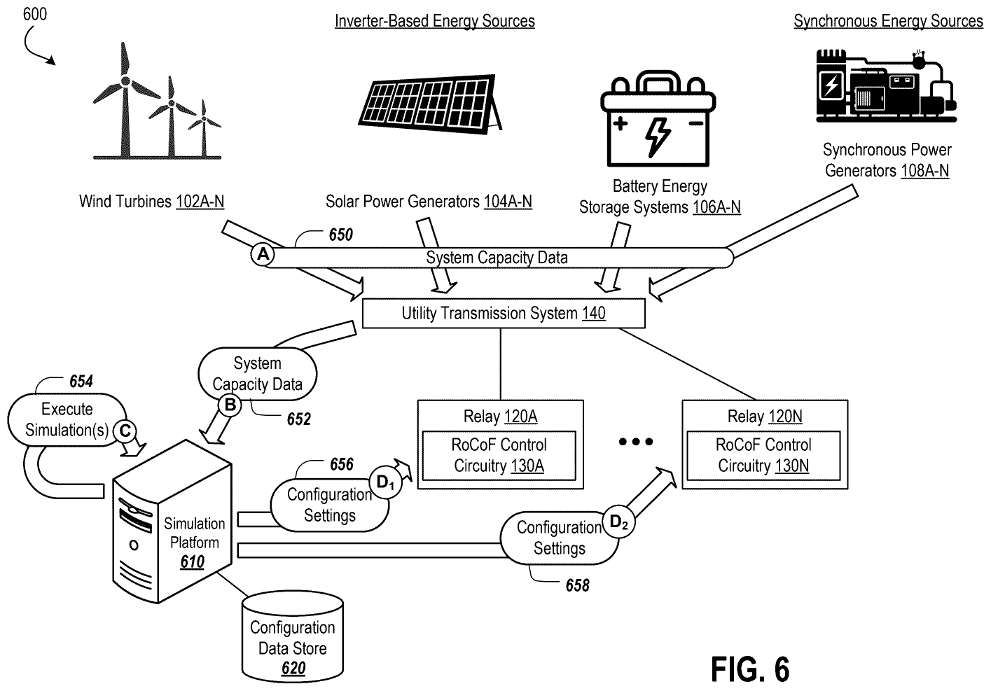

Referring now to FIG. 6, an example illustrative process is shown for performing simulations of under-frequency events, and applying configuration settings determined during the simulations to RoCoF control circuitry of relays, as represented in example stages (A) to (D). Stages (A) to (D) may occur in the illustrated sequence, or they may occur in a sequence that is different than in the illustrated sequence, and/or two or more stages (A) to (D) may be concurrent. In some examples, one or more stages (A) to (D) may be repeated multiple times when performing simulations of under-frequency events and/or when applying configuration settings to control circuits of relays.

In the present example, the process for performing simulations of under-frequency events and applying determined configuration settings to RoCoF control circuitry of relays can be performed within an electric power transmission system 600 (e.g., similar to the electric power transmission system 100 shown in FIGS. 1A-1B), with the addition of a simulation platform 610 and a configuration data store 620. The simulation platform 610, for example, can be configured to perform simulations of under-frequency events for various different electric power transmission systems, including the electric power transmission system 600. Example test data and test results determined during simulations of under-frequency events are described herein with respect to FIGS. 4A-4D. In general, the simulation platform 610 can represent various forms of servers, including but not limited to network servers, web servers, application servers, or other suitable computing servers. The configuration data store 620, for example, can be configured to maintain data used for performing simulations of under-frequency events, including data that represents the inverter-based energy resources (e.g., the wind turbines 102A-N, the solar power generators 104A-N, the battery energy storage systems (BESS) 106A-N, etc.) and the synchronous power generators 108A-N, configuration settings of the RoCoF control circuitry 130A-N of the relays 120A-N (e.g., settable values of frequency detection elements, amounts of system load to trip, timer values, etc.), and various loads (e.g., the loads 110A-N, shown in FIGS. 1A-1B). Further, the configuration data store 620 can be configured to maintain data that represents the results of such simulations, and mappings between optimal configuration settings as determined by the simulations (e.g., configuration settings that can be used to trip a minimum amount of load for a given electric power transmission system having a given mix of inverter-based energy sources and synchronous energy sources). In general, the configuration data store 620 can represent one or more databases, file systems, and/or cached data sources.

During stage (A), system capacity data can be received. For example, the utility transmission system 140 can receive capacity data 650 that represents a current capacity of the electric power transmission system 600, including a capacity of each of the inverter-based energy sources (e.g., sources 102A-N, 104A-N, and 106A-N) and each of the synchronous energy sources (e.g., sources 108A-N) for providing electric power to the system 600. In some implementations, the capacity data 650 can be provided in real time or near real time. For example, as the capacity of the electric power transmission system 600 changes over time (e.g., as inverter-based energy sources and synchronous energy sources come online, drop offline, and/or an amount of power that can be generated/delivered by the sources changes), real time updates in the capacity data 650 can be provided to the electric power transmission system 600.

During stage (B), system capacity data can be provided to a simulation platform. For example, the utility transmission system 140 can provide system capacity data 652 (e.g., representing at least a portion of the system capacity data 650) to the simulation platform 610. The system capacity data 652, for example, can be provided periodically (e.g., once per hour, once per day, once per week, or at another suitable interval) and/or can be provided in response to a change in the capacity of the electric power transmission system 600 that is likely to impact results generated by the simulation platform 610.

During stage (C), one or more simulations can be performed of an under-frequency event in an electric power transmission system. For example, the simulation platform 610 can execute one or more simulations 654 of an under-frequency event in the electric power transmission system 600, based on the system capacity data 652. In general, a worst case under-frequency event can be an event in which 30-40% of system capacity is lost at once. For worst case under-frequency events, and in particular when a high percentage of inverter-based energy resources are generating power within the system 600, for example, severe RoCoF may exist. By performing simulations of such worst cast under-frequency events, for example, appropriate frequency bands, tripping delay values, and amounts of load to trip, can be determined for handling the events across various initial RoCoF and deceleration RoCoF values. In the present example, performing the under-frequency simulation(s) 654, can involve modeling the operations of the system 600, using a collection of state variables that represent the utility transmission system 140, the various relays 120A-N and RoCoF control circuitry 130A-N, the various inverter-based energy sources (e.g., sources 102A-N, 104A-N, 106A-N, etc.) and synchronous energy sources (e.g., generators 108A-N), and the loads 110A-N within the system 600. The state variables, for example, can be modified by the simulations to model the evolution of the system 600 over time.

In some implementations, based on results of one or more simulations of an under-frequency event, optimized values can be determined for configuration settings that pertain to various aspects of RoCoF control logic used within an electric power transmission system. In general, the configuration settings can be used to adjust initial RoCoF frequency bands, deceleration RoCoF frequency bands, tripping delay timers, and amounts of load to trip in response to system conditions. For example, as a result of executing the simulations(s) 654, the simulation platform 610 can determine appropriate frequency values for settable frequency detection elements (e.g., FREQ_1, FREQ_2, FREQ_3, and FREQ_4, shown in FIGS. 3A-3F), settable initial timer values (e.g., values of the initial timers T1, T2, T3, and T4, also shown in FIGS. 3A-3F), and settable tripping delay timer values (e.g., values of the timers T1a, T1b, T2a, T2b, T3a, T3b, and T4a, T4b, also shown in FIGS. 3A-3F) that together are used to determine respective adjustable frequency bands for an initial RoCoF and a deceleration RoCoF, and an amount of time for a tripping delay. Further, each of the frequency bands for the initial RoCoF can be associated with a respective amount of load to trip, which can be represented through additional settable values determined by the simulation platform 610. The optimized values, for example, can include values that minimize an amount of load to trip while avoiding over-frequency conditions (in which a system frequency overshoots a target frequency), for a simulated under-frequency event.

During stages (D₁) and (D₂), control circuitry of the energy transmission system can be reconfigured based on the optimized values. For example, after executing the simulation 654, configuration settings 656, 658 that are based on optimized values determined by the simulation platform 610 for the simulated under-frequency event can be transmitted for reconfiguring the respective RoCoF control circuitry 130A of the relay 120A and the RoCoF control circuitry 130N of the relay 120N. The configuration settings 656, 658, for example, can be the same configuration settings or can be different configuration settings. For example, different relays on the utility transmission system 140 can potentially serve portions of the electric power transmission system 600 that respond differently during under-frequency events and/or that serve different amounts/types of load.

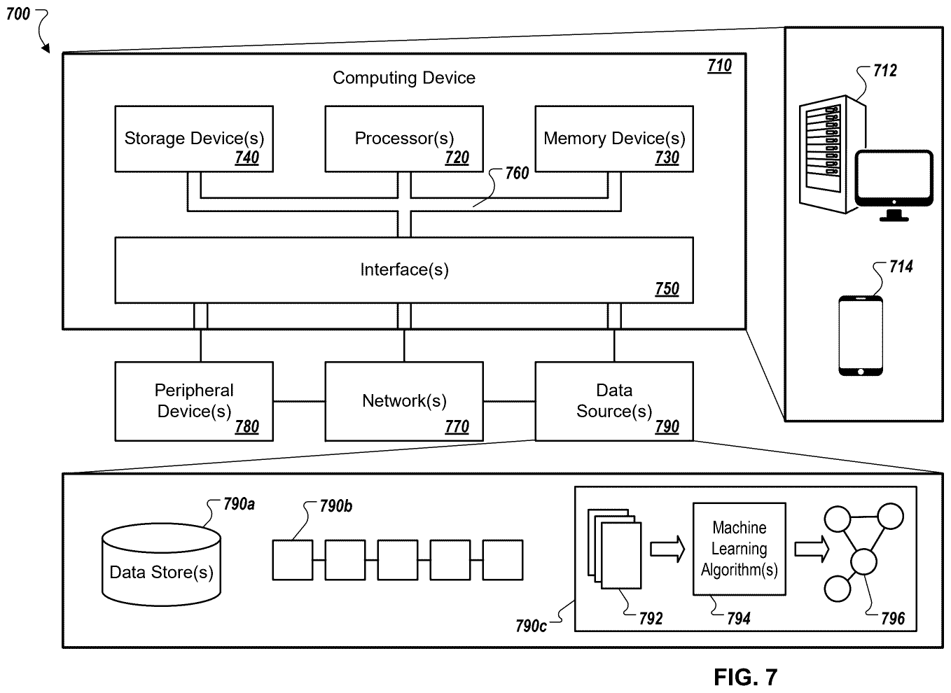

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 750 can include various communications interfaces (e.g., USB, Near-Field Communication (NFC), Bluetooth, WiFi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 790c. The machine learning system(s) 790c, for example, can be used to analyze data from various sources (e.g., data provided by the computing device 710, data from the data store(s) 790a, data from the blockchain(s) 790b, and/or data from other data sources), to identify patterns in the data, and to draw inferences from the data patterns. In general, training data 792 can be provided to one or more machine learning algorithms 794, and the machine learning algorithm(s) can generate a machine learning model 796. Execution of the machine learning algorithm(s) can be performed by the computing device 710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents energy sources, relays, and loads within an electric power transmission system. The machine learning model that results from the machine learning algorithm(s) can be used to approximate the behavior of the energy sources, relays, and loads during an under-frequency event. Use of the machine learning model can provide the benefit of improved simulation performance across various possible system configurations and event severities.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for tripping energy loads in an energy transmission system based on Rate of Change of Frequency (RoCoF), the method comprising:
detecting an initial RoCoF of electrical voltage in the energy transmission system;
determining that the initial RoCoF falls within one of n predetermined frequency bands;
in response to determining that the initial RoCoF falls within one of n predetermined frequency bands, arming an amount of energy load to trip that corresponds to the one of n predetermined frequency bands;
after detecting the initial RoCoF, starting at least one tripping delay timer;
while the at least one tripping delay timer is running, (i) detecting a deceleration RoCoF of electrical voltage in the energy transmission system, and (ii) detecting that a frequency of the electrical voltage has decayed past a tripping frequency threshold;
in response to detecting that the frequency of the electrical voltage has decayed past the tripping frequency threshold, determining a time at which to trip the amount of energy load, based at least in part on the deceleration RoCoF of electrical voltage; and
tripping the amount of energy load at the determined time.

2. The method of claim 1, wherein the method is performed by control circuitry of a relay of the energy transmission system.

3. The method of claim 1, wherein the amount of energy load to trip is proportional to the initial RoCoF, according to the one of n predetermined frequency bands in which the initial RoCoF falls.

4. The method of claim 1, wherein determining the time at which to trip the amount of energy load comprises determining whether to (i) extend the at least one tripping delay timer, or (ii) immediately trip the amount of energy load.

5. The method of claim 1, wherein detecting the initial RoCoF of electrical voltage comprises:
detecting that the frequency of electrical voltage has decayed past a first frequency threshold;
simultaneously starting a set of initial timers, with each consecutive initial timer of the set of initial timers being configured to assert after a progressively increasing initial timer interval has elapsed;
after starting the set of initial timers, detecting that the frequency of electrical voltage has decayed past a second frequency threshold;
in response to detecting that the frequency of electrical voltage has decayed past the second frequency threshold, determining which initial timers of the set of initial timers have asserted; and
determining that the initial RoCoF has a value that corresponds to the initial timers of the set of initial timers that have asserted.

6. The method of claim 5, wherein the at least one tripping delay timer comprises a set of tripping delay timers.

7. The method of claim 6, wherein detecting the deceleration RoCoF of electrical voltage comprises:
in response to detecting that the frequency of electrical voltage has decayed past the second frequency threshold, simultaneously starting the set of tripping delay timers, with each consecutive tripping delay timer of the set of tripping delay timers being configured to assert after a progressively increasing tripping delay timer interval has elapsed;
after starting the set of tripping delay timers, detecting that the frequency of electrical voltage has decayed past the tripping frequency threshold;
in response to detecting that the frequency of electrical voltage has decayed past the tripping frequency threshold, determining which tripping delay timers of the set of tripping delay timers have asserted; and
determining that the deceleration RoCoF has a value that corresponds to the tripping delay timers of the set of tripping delay timers that have asserted.

8. The method of claim 6, wherein each tripping delay timer of the set of tripping delay timers is paired with a corresponding initial timer of the set of initial timers, with the tripping delay timer being configured for use in detecting a deceleration RoCoF that is in the range of 50-75% of a lower bound of a predetermined frequency band that is associated with the corresponding initial timer.

9. The method of claim 1, further comprising:
conducting at least one simulation of an under-frequency event in the energy transmission system;
based on results of the at least one simulation, determining optimized values for the n predetermined frequency bands, for the amounts of load to trip that correspond to the n predetermined frequency bands, and for the at least one tripping delay timer; and
reconfiguring control circuitry of the energy transmission system based on the optimized values.

10. The method of claim 9, further comprising:
detecting a change in capacity in the energy transmission system, wherein the at least one simulation of the under-frequency event is conducted in response to detecting the change in capacity.

11. A relay apparatus for tripping energy loads in an energy transmission system based on Rate of Change of Frequency (RoCoF), the relay apparatus being configured to perform operations comprising:
detecting an initial RoCoF of electrical voltage in the energy transmission system;
determining that the initial RoCoF falls within one of n predetermined frequency bands;
in response to determining that the initial RoCoF falls within one of n predetermined frequency bands, arming an amount of energy load to trip that corresponds to the one of n predetermined frequency bands;
after detecting the initial RoCoF, starting at least one tripping delay timer;
while the at least one tripping delay timer is running, (i) detecting a deceleration RoCoF of electrical voltage in the energy transmission system, and (ii) detecting that a frequency of the electrical voltage has decayed past a tripping frequency threshold;
in response to detecting that the frequency of the electrical voltage has decayed past the tripping frequency threshold, determining a time at which to trip the amount of energy load, based at least in part on the deceleration RoCoF of electrical voltage; and
tripping the amount of energy load at the determined time.

12. The relay apparatus of claim 11, wherein the method is performed by control circuitry of a relay of the energy transmission system.

13. The relay apparatus of claim 11, wherein the amount of energy load to trip is proportional to the initial RoCoF, according to the one of n predetermined frequency bands in which the initial RoCoF falls.

14. The relay apparatus of claim 11, wherein determining the time at which to trip the amount of energy load comprises determining whether to (i) extend the at least one tripping delay timer, or (ii) immediately trip the amount of energy load.

15. The relay apparatus of claim 11, wherein detecting the initial RoCoF of electrical voltage comprises:
detecting that the frequency of electrical voltage has decayed past a first frequency threshold;
simultaneously starting a set of initial timers, with each consecutive initial timer of the set of initial timers being configured to assert after a progressively increasing initial timer interval has elapsed;
after starting the set of initial timers, detecting that the frequency of electrical voltage has decayed past a second frequency threshold;
in response to detecting that the frequency of electrical voltage has decayed past the second frequency threshold, determining which initial timers of the set of initial timers have asserted; and
determining that the initial RoCoF has a value that corresponds to the initial timers of the set of initial timers that have asserted.

16. The relay apparatus of claim 15, wherein the at least one tripping delay timer comprises a set of tripping delay timers.

17. The relay apparatus of claim 16, wherein detecting the deceleration RoCoF of electrical voltage comprises:
in response to detecting that the frequency of electrical voltage has decayed past the second frequency threshold, simultaneously starting the set of tripping delay timers, with each consecutive tripping delay timer of the set of tripping delay timers being configured to assert after a progressively increasing tripping delay timer interval has elapsed;
after starting the set of tripping delay timers, detecting that the frequency of electrical voltage has decayed past the tripping frequency threshold;
in response to detecting that the frequency of electrical voltage has decayed past the tripping frequency threshold, determining which tripping delay timers of the set of tripping delay timers have asserted; and
determining that the deceleration RoCoF has a value that corresponds to the tripping delay timers of the set of tripping delay timers that have asserted.

18. The relay apparatus of claim 16, wherein each tripping delay timer of the set of tripping delay timers is paired with a corresponding initial timer of the set of initial timers, with the tripping delay timer being configured for use in detecting a deceleration RoCoF that is in the range of 50-75% of a lower bound of a predetermined frequency band that is associated with the corresponding initial timer.

19. The relay apparatus of claim 11, comprising:
an initial RoCoF detector logic component;
a secondary RoCoF deceleration detector logic component;
a fast transient filter component;
an under-voltage inhibitor logic component;
a supervised under-frequency trip logic component; and
a supervised automatic load restoration logic component configured to determine whether to restore the energy load by a predetermined amount.
